(19) United States
(12) Patent Application Publication
(10) Pub. No.: US 2024/0247380 A1
(43) Pub. Date: Jul. 25, 2024

(54) HYDROGEN PRODUCTION SYSTEM USING AMMONIA AND FUEL CELL USING AMMONIA

(71) Applicant: AAR INC., Uisan (KR)

(72) Inventors: Gun Tae KIM, Ulsan (KR); Ye-Jin YANG, Ulsan (KR); Jeong-Won KIM, Ulsan (KR)

(73) Assignee: AAR INC., Ulsan (KR)

(21) Appl. No.: 18/290,535

(22) PCT Filed: May 16, 2022
(86) PCT No.: PCT/KR2022/006989

§ 371 Date: Nov. 14, 2023

(30) Foreign Application Priority Data
May 17, 2021 (KR) 10-2021-0063305
Oct. 13, 2021 (KR) 10-2021-0135865
Mar. 2, 2022 (KR) 10-2022-0026684
Mar. 7, 2022 (KR) 10-2022-0028466
May 3, 2022 (KR) 10-2022-0054983

(51) Int. Cl. C25B 1/04; C25B 9/19; C25B 11/042; C25B 13/02; H01M 4/86; H01M 4/88; H01M 4/94; H01M 8/22; H01M 16/00

(52) U.S. Cl. CPC C25B 1/04; C25B 9/19; C25B 11/042; C25B 13/02; H01M 4/8807; H01M 4/94; H01M 8/222; H01M 16/003; H01M 2004/8684; H01M 2004/8689

(57) ABSTRACT

A hydrogen production system according to the present invention can reduce the power consumed for hydrogen production, has no consumption of cell potential, and can produce hydrogen even by spontaneous reaction to show high hydrogen production efficiency. Furthermore, a composite electrode separator according to the present invention is configured such that an electrode part, a gas-liquid diffusion layer, and a separation plate as a plurality of parts are integrated into one element while the hydrogen production system is included in the electrode part, so that the application of the composite electrode separator to a stack can reduce the number of parts applied to the stack to simplify stack assembling and reduce the stack volume and can increase the operation current density due to a reduction in electrolyte resistance, thereby enabling high-efficiency and high-current driving. Furthermore, a composite hydrogen production stack according to the present invention can not only produce hydrogen gas and electric power together or produce only electric power by adjusting the amount of oxygen, but also produce only hydrogen gas through ammonia water electrolysis. Furthermore, an ammonia fuel cell according to the present invention, by using ammonia as fuel, is an eco-friendly energy source and relatively easy to supply as fuel, has a narrower explosion range than hydrogen, can be liquefied at a low pressure to be easy to store and transport, facilitates leakage detection due to the distinctive smell of ammonia, and can attain wastewater disposal and electricity production simultaneously when ammonia wastewater is utilized.

### TECHNICAL FIELD

The present invention relates to a hydrogen production system using ammonia, a combined power generation system using the hydrogen production system, a composite electrode separator in which the hydrogen production system is integrally formed, a composite hydrogen production stack including the composite electrode separator, and a fuel cell using ammonia.

### BACKGROUND ART

Due to greenhouse gas emissions and global warming problems, there is a growing need to develop renewable energy that will be replaced with fossil fuels. Hydrogen is attracting attention as a renewable energy source because it does not emit substantially any pollutants even after combustion. However, hydrogen has a disadvantage in that complex facilities or processes are required to store and transport hydrogen.

Since ammonia has three hydrogen atoms per molecule and is decomposed to generate only hydrogen and nitrogen, carbon dioxide emission may be minimized, and thus ammonia is attracting attention as a hydrogen source. In addition, since ammonia has already been produced for industrial uses and is used all over the globe, existing ammonia infrastructure may be used, and thus ammonia has many advantages in terms of transportation or storage. Accordingly, a hydrogen production method using ammonia is being developed.

However, a thermal decomposition method, which is one of conventional hydrogen production methods using ammonia, has disadvantages in that a high temperature of 400° C. or more is required, and also the use of an expensive catalyst is required. In addition, an alkali metal amide method also has a high unit cost and thus has low economic feasibility, and a water electrolysis method also has a disadvantage in that external power supply is required.

Accordingly, there is a need for a hydrogen production system or the like capable of improving operating current density by reducing electrolyte resistance while reducing consumption of externally supplied power.

In addition, due to greenhouse gas emissions and global warming problems, there is a growing need to develop renewable energy that will be replaced with fossil fuels. Accordingly, power generation systems using renewable energy such as solar power or wind power are being developed. However, renewable energy generation has a problem that electricity output fluctuates depending on the natural environment. Accordingly, there is a need to research a method in which, when power exceeds the power demand, surplus power is stored, and for example, when a power amount is low or absent in solar power generation at night, stored energy is used as spare power.

As such, as a way to better utilize renewable energy sources, systems using hydrogen energy, in which hydrogen is produced using surplus power and stored and, when a power amount is low, a fuel cell produces power using the stored hydrogen and supplies the produced power, have been proposed. However, in the case of systems using hydrogen energy, since hydrogen is produced and stored using surplus energy, hydrogen production and storage may not be smooth. Accordingly, there is a need to develop a system capable of producing a large amount of hydrogen with only a small amount of energy.

Meanwhile, alkaline fuel cells are fuel cells that use an alkaline solution, such as KOH or NaOH, as an electrolyte and are electrochemical energy conversion devices in which hydrogen and oxygen combine to generate water and electricity. Like other fuel cells, alkaline fuel cells are environmentally friendly and have many advantages such as high energy conversion efficiency, but since an electrolyte reacts with carbon dioxide to produce salt, only pure hydrogen and oxygen may be used as a fuel, and thus there are difficulties in fuel supply.

Therefore, there is a need to develop a fuel cell which is an environmentally friendly energy source and from which fuel supply is relatively easy.

### DISCLOSURE

### Technical Problem

The objects for solving the above problem are as follows.

The present is directed to providing a hydrogen production system using ammonia, which is capable of reducing the consumption of power supplied by an external power source.

The present invention is also directed to providing a combined power generation system using the hydrogen production system and renewable energy power generation.

The present invention is also directed to providing a composite electrode separator in which the hydrogen production system is used as an electrode part, and a plurality of components of the electrode part, a gas-liquid diffusion layer, and a separator are integrated into one structure.

The present invention is also directed to providing a composite hydrogen production stack including the composite electrode separator.

The present invention is also directed to providing an ammonia fuel cell in which ammonia is used as a raw material, nitrogen (N₂) is generated in an anode part, and a concentration of oxygen dissolved in a first electrolyte in a cathode part is adjusted to adjust a cell potential and generate hydrogen (H₂) as needed.

### Technical Solution

According to one embodiment of the present invention, a hydrogen production includes a cathode part including a cathode and a first electrolyte, an anode part including an anode and a second electrolyte, and a bipolar membrane disposed between the cathode part and the anode part, wherein the first electrolyte is neutral, the second electrolyte is alkaline and includes ammonia, and hydrogen is generated in the cathode part.

The cathode may include a hydrogen evolution reaction catalyst.

The hydrogen evolution reaction catalyst may include at least one selected from the group consisting of a metal foam, a metal thin film, carbon paper, carbon fiber, carbon felt, carbon cloth, and a platinum catalyst.

The anode may include at least one metal catalyst selected from platinum (Pt), iridium (Ir), rhodium (Rh), ruthenium (Ru), iron (Fe), cobalt (Co), nickel (Ni), and copper (Cu).

The first electrolyte may have a pH of 6 to 8.

The second electrolyte may have a pH of 12 to 15.

The first electrolyte may be a neutral aqueous electrolyte, and the second electrolyte may be an alkaline aqueous electrolyte including ammonia.

The alkaline aqueous electrolyte may be an alkaline aqueous solution in which at least one selected from alkali metal hydroxides is dissolved.

The alkali metal hydroxide may be at least one selected from the group consisting of KOH, NaOH, and LiOH.

The bipolar membrane may decompose water into protons (H⁺) and hydroxide ions (OH⁻), the protons (H⁺) may move to the first electrolyte, and the hydroxide ions (OH⁻) may move to the second electrolyte.

An ammonia oxidation reaction, in which ammonia reacts with hydroxide ions (OH⁻) and is oxidized to produce nitrogen (N₂), may occur in the anode part.

A temperature of the anode part may be 30° C. or more.

A concentration of the alkaline aqueous solution may be 1 M or more.

A concentration of the ammonia may be in a range of 0.7 M or more and 1.3 M or less.

The hydrogen in the cathode part may be generated through a hydrogen evolution reaction in which protons (H⁺) combine with electrons of the cathode to generate hydrogen (H₂).

The hydrogen production system may further include an oxygen adjustment part connected to the cathode part to adjust an amount of oxygen input to the cathode part.

When a concentration of oxygen dissolved in the first electrolyte in the cathode part is 12% or less, electrons in the cathode part may react with water (H₂O) to generate hydrogen (H₂).

When a concentration of oxygen dissolved in the first electrolyte in the cathode part is more than 12%, electrons in the cathode part may react with water (H₂O) and oxygen (O₂) to generate Hydroxide ions (OH⁻).

According to another embodiment, a method of stabilizing an electrode by removing poisoning from a poisoned electrode in a hydrogen production system includes performing a cathodic scan on the hydrogen production system, wherein the hydrogen production system includes a cathode part including a cathode and a first aqueous electrolyte, an anode part including an anode and a second aqueous electrolyte, and a bipolar membrane disposed between the cathode part and the anode part, wherein a hydrogen evolution reaction, in the cathode part, and an ammonia oxidation reaction occurs in the anode part, occurs.

According to still another embodiment, a combined power generation system includes a renewable energy generation unit configured to produce power from renewable energy, a hydrogen production unit configured to receive the power produced from the renewable energy generation unit, and a fuel cell configured to receive hydrogen from the hydrogen production unit, wherein the hydrogen production unit is the hydrogen production system according to one embodiment.

The combined power generation system may further include a hydrogen storage unit configured to store the hydrogen produced in the hydrogen production unit.

The combined power generation system may further include an electric energy storage unit configured to store the power produced from the renewable energy generation unit.

According to yet another embodiment, a composite electrode separator includes a separation part having a plate shape, a transport part formed on each of two surfaces of the separation part and having a flow path through which a reactant and a product flow and an input/output hole through which the reactant flows in and the product flows out, a reaction part having an area other than the transport part formed on each of the two surfaces, and an electrode part positioned in the reaction part and including a cathode, an anode, and a bipolar membrane disposed between the cathode and the anode.

The input/output hole may include a cathode input/output hole and an anode input/output hole.

A cathode input/output hole may further include an oxygen adjustment part configured to adjust an amount of oxygen of the reactant flowing into the transport part.

A hydrogen ion concentration of the reactant flowing in through a cathode input/output hole may be in a range of pH 6 to pH 8.

A hydrogen ion concentration of the reactant flowing in through the input/output hole may be in a range of pH 12 to pH 15.

The electrode part may have a specific surface area of 5 m²/g to 100 m²/g and a pore size of 0.02 μm to 12 μm.

According to yet another embodiment, a composite hydrogen production stack includes one or more unit cells each including the composite electrode separator according to still another embodiment and current collector plates positioned on two surfaces of the electrode separator.

When a concentration of oxygen in the reactant flowing in through a cathode input/output hole is 12% or less, electrons of the cathode may react with water (H₂O) to discharge hydrogen (H₂) as a product.

When a concentration of oxygen in the reactant flowing in through the cathode input/output hole is more than 12%, electrons of the cathode may react with water (H₂O) and oxygen (O₂) to generate hydroxide ions (OH⁻).

Ammonia (NH₃) and hydroxide ion (OH⁻) may be oxidized at the anode to discharge nitrogen (N₂) as a product through an anode input/output hole.

A spontaneous reaction, in which a current density of more than 0 mA/cm² and less than or equal to 100 mA/cm² is generated at a cell potential ranging from 0 V to 0.6 V, may occur.

A current density exceeding 100 mA/cm² may be generated through an ammonia water electrolysis reaction.

According to yet another embodiment, an ammonia fuel cell includes a cathode part including a first electrolyte accommodated in a first accommodation space and a cathode of which at least a portion is submerged in the first electrolyte, an anode part including a second electrolyte accommodated in a second accommodation space and a metal anode of which at least a portion is submerged in the second electrolyte, and a connection part including a connection passage configured to communicate the first accommodation space with the second accommodation space, and an anion exchange membrane provided in the connection passage to allow anions to move, wherein the first electrolyte is neutral, the second electrolyte includes ammonia (NH₃) and is alkaline, and nitrogen (N₂) is generated in the anode part.

The ammonia fuel cell may further include an oxygen adjustment part connected to the first accommodation space of the cathode part to adjust an amount of oxygen input the first accommodation space.

When a concentration of oxygen dissolved in the first electrolyte in the cathode part is 12% or less, electrons in the cathode part may react with water (H₂O) to generate hydrogen (H₂).

When the concentration of oxygen dissolved in the first electrolyte in the cathode part is more than 12%, electrons in the cathode part may react with water (H₂O) and oxygen (O₂) to generate hydroxide ions (OH⁻).

The anion exchange membrane may be pretreated in an alkaline environment.

The pretreatment may be performed using an alkaline solution at 0.1 M to 1 M.

Ammonia (NH₃) and hydroxide ions (OH⁻) may be oxidized in the anode part to generate nitrogen (N₂).

A hydrogen ion concentration of the first electrolyte may be in a range of pH 6 to pH 8.

A hydrogen ion concentration of the second electrolyte may be in a range of pH 12 to pH 15.

The second electrolyte may include an alkaline aqueous solution in which an alkali metal oxide is dissolved.

A current density of more than 0 mA/cm² and less than or equal to 50 mA/cm² may be generated at a cell potential ranging from 0 V to 1.0 V.

### Advantageous Effects

In a hydrogen production system according to the present invention, power consumed to produce hydrogen can be reduced, and hydrogen gas and power can be produced together in an operating environment in which a cell potential is not consumed so that hydrogen production efficiency can be high.

In addition, according to the present invention, in a combined power generation system including the hydrogen production system and using renewable energy, there are advantages in that, in response to fluctuations in electricity output due to a natural environment, surplus power can be used for producing and storing hydrogen, and when a power amount is low or absent, a fuel cell can produce and supply power using the stored hydrogen.

In addition, since a composite electrode separator according to the present invention includes the hydrogen production system as an electrode part, and a plurality of components of the electrode part, a gas-liquid diffusion layer, and a separation plate are provided to be integrated into one structure, when the composite electrode separator is applied to a stack, the number of parts applied to the stack can be reduced to simplify a stack assembly, reduce a stack volume, and also reduce electrolyte resistance, and thus operating current density can be increased, which enables the high-efficiency and high-current operation.

In addition, in a composite hydrogen production stack according to the present invention, an amount of oxygen can be adjusted to produce hydrogen gas and power together or produce only power, and also only hydrogen gas can be produced through an ammonia water electrolysis reaction.

Furthermore, by using ammonia as a fuel, an ammonia fuel cell according to the present invention is an eco-friendly energy source, it is relatively easy to supply a fuel, ammonia has a narrower explosion range than hydrogen and is easy to store and transport because it can be liquefied at low pressure. In addition, it is easy to detect leaks due to the unique smell of ammonia, and when ammonia wastewater is used, there is an advantage in that electricity can be produced at the same time when wastewater is treated. The ammonia fuel cell is an electrochemical system in which a spontaneous electrochemical potential is generated, and a concentration of oxygen is adjusted to adjust a cell potential and generate hydrogen (H₂) as needed. Thus, there is an advantage in that the generated hydrogen (H₂) can be used as a fuel for other fuel cells and introduced into a composite fuel cell system.

### DESCRIPTION OF DRAWINGS

FIG. 1 is a schematic view illustrating a hydrogen production system according to one embodiment.

FIG. 2 is a schematic illustrating a combined power generation system (1) according to one embodiment.

FIG. 3 is a front view of a composite electrode separator according to one embodiment.

FIG. 4 is an exploded view of a composite hydrogen production stack including a composite electrode separator according to one embodiment.

FIG. 5 is a schematic view illustrating an ammonia fuel cell system (100″) according to one implementation.

FIGS. 6A to 6C are a potential-current density graph of an anode part (FIG. 6A) and a potential-current density graph of a cathode part (FIG. 6B) in a hydrogen production system according to one embodiment, and a potential-current density graph (FIG. 6C) of the entire system.

FIG. 7 is a graph showing a voltage according to current density measured in a hydrogen production system (hydrogen production unit of a combined power generation system) according to one embodiment.

FIG. 8 is a graph showing a change in electrochemical performance according to a temperature in a hydrogen production system according to one embodiment.

FIG. 9 is a graph showing a change in electrochemical performance according to a concentration of an alkali metal hydroxide in a second electrolyte of an anode part in a hydrogen production system according to one embodiment.

FIG. 10 is a graph showing a change in electrochemical performance according to a concentration of ammonia in a second electrolyte of an anode part in a hydrogen production system according to one embodiment.

FIGS. 11A and 11B show results obtained in a chemical poisoning removal experiment of Example 5, wherein FIG. 11A is a graph showing poisoning removal and electrochemical performance recovery according to a cathodic scan, and FIG. 11B is a graph showing the occurrence of poisoning at an anode part and a cathodic scan process corresponding thereto.

FIG. 12 is a graph showing results of measuring a cell potential of a composite hydrogen production stack according to Example 6.

FIG. 13 is a graph showing current density according to a cell potential of the composite hydrogen production stack according to Example 6.

FIG. 14 is a graph of analyzing a reaction according to the addition of oxygen in the composite hydrogen production stack according to Example 6.

FIG. 15 is a graph showing results of measuring a cell potential of an ammonia fuel cell according to Example 9.

FIG. 16 is a graph showing results of analyzing an ammonia fuel cell including a pretreated anion exchange membrane according to Example 10 using a linear sweep voltammetry (LSV).

### MODES OF THE INVENTION

Hereinafter, the present invention will be described in detail.

Terms used in this application are merely used to describe specific embodiments and are not intended to limit the present invention. Unless defined otherwise, all the terms (including technical and scientific terms) used herein have the same meaning as commonly understood by one of ordinary skill in the art to which the present invention belongs.

Throughout the specification, when a portion “includes,” “contains,” or “has” an element, another element may be further included, rather than excluding the existence of the other element, unless otherwise described.

The terms “first,” “second,” and the like are used to differentiate a certain element from another element, but elements should not be construed to be limited by the terms.

It will be understood that when a first part is referred to as being “on” a second part, the first part can be directly on the second part or intervening parts may also be present. By contrast, it will be understood that when a first part is referred to as being “directly on” a second part, intervening parts are not present.

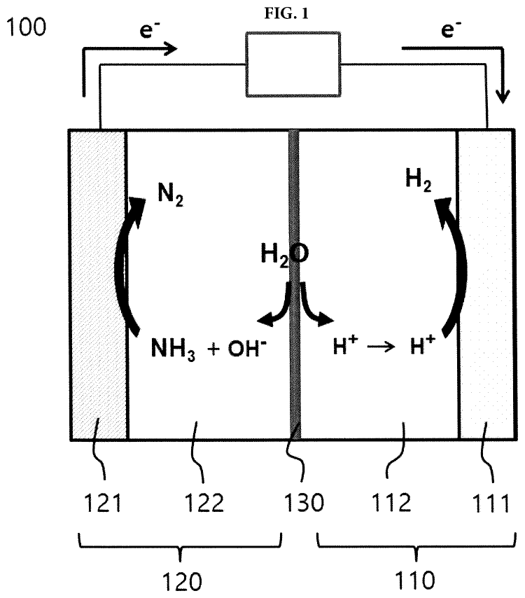

FIG. 1 is a schematic view illustrating a hydrogen production system according to the present invention.

Referring to FIG. 1, a hydrogen production system 100 according to the present invention includes a cathode part 110 including a cathode 111 and a first electrolyte 112, an anode part 120 including an anode 121 and a second electrolyte 122, and a bipolar membrane 130 disposed between the cathode part 110 and the anode part 120.

Hydrogen is generated in the cathode part 110. In the cathode part 110, the hydrogen is produced through a hydrogen evolution reaction in which protons (H⁺) combine with electrons of the cathode 111 to generate hydrogen (H₂). Preferably, water may be decomposed into protons (H⁺) and hydroxide ions (OH⁻) through water decomposition in the bipolar membrane 130, and thus the formed protons (H⁺) may be moved to the first electrolyte 112. The protons (H⁺) formed by the bipolar membrane 130 may move through the first electrolyte 112, and the cathode 111 may receive electrons to produce hydrogen gas. Specifically, the hydrogen evolution reaction occurring in the cathode part 110 may be as shown in Reaction Formula 1 below.

$$2 {H}^{+} + 2 {e}^{-} \to {H}_{2} \qquad [ Reaction Formula 1 ]$$

That is, in the cathode part 110, protons (H⁺) receive electrons (e⁻), and hydrogen (H₂) gas is generated.

Meanwhile, the cathode part may further include an oxygen adjustment part connected to the cathode part to adjust an amount of oxygen input to the cathode part. The cathode part may adjust an amount of input oxygen through the oxygen adjustment part, and thus a reaction for generating more hydrogen may occur according to a concentration of oxygen dissolved in the first electrolyte.

Specifically, an amount of oxygen input to a first accommodation space may be reduced through the oxygen adjustment part, and thus when a concentration of oxygen dissolved in the first electrolyte in the cathode part is low, is preferably 12% or less, and is more preferably more than 0% and 12% or less, electrons in the cathode part may react with water (H₂O) to generate hydrogen (H₂). That is, when a concentration of oxygen dissolved in the first electrolyte in the cathode part is low, a hydrogen evolution reaction may occur as shown in Reaction Formula 2 below.

$$2 {H}_{2} O + 2 {e}^{-} \to {H}_{2} + 2 {OH}^{-} ( - 0.473 V vs . SHE ) \qquad [ Reaction Formula 2 ]$$

The hydrogen production system 100 may further include a first outlet (not shown) connected to the cathode part 110 to discharge hydrogen (H₂) gas generated in the cathode part 110. Hydrogen gas may be discharged to the outside from the cathode part 110 through the first outlet.

Meanwhile, an amount of oxygen input to a first accommodation space may be increased through the oxygen adjustment part, and thus when a concentration of oxygen dissolved in the first electrolyte in the cathode part is high, is preferably more than 12%, and is more preferably more than 12% and less than 100%, electrons in the cathode part may undergo an oxygen reduction reaction with water (H₂O) and oxygen (O₂) to generate hydroxide ions (OH⁻). That is, when a concentration of oxygen dissolved in the first electrolyte in the cathode part is high, an oxygen reduction reaction may occur as shown in Reaction Formula 3 below.

$${O}_{2} + 2 {H}_{2} O + 4 {e}^{-} \to 4 {OH}^{-} ( 0.873 V vs . SHE ) \qquad [ Reaction Formula 3 ]$$

The cathode part 110 includes the cathode 111 (reduction electrode). The cathode 111 may include a hydrogen evolution reaction catalyst. The hydrogen evolution reaction catalyst may include, for example, at least one selected from the group consisting of a metal foam, a metal thin film, carbon paper, carbon fiber, carbon felt, carbon cloth, and a platinum catalyst, but the present invention is not limited thereto. The cathode 111 may have an arrangement in which one side thereof is in contact with the first electrolyte 112, but alternatively, the cathode 111 may have an arrangement in which at least a portion of the cathode 111 is immersed in the first electrolyte 112.

The cathode part 110 includes the first electrolyte 112. The first electrolyte 112 may be neutral and for example, may have a hydrogen ion concentration (pH) of 6 to 8, specifically a pH of about 7. The first electrolyte 112 may be an aqueous electrolyte, specifically a neutral aqueous electrolyte containing water. The first electrolyte 112 may further include other electrolyte materials other than water. Except that other electrolyte materials should be electrolyte materials that neutralize the pH of the first electrolyte 112, types of other electrolyte materials other than water are not particularly limited, and any electrolyte material known in the art may be used. The electrolyte material may be, for example, a neutral electrolyte material, and for example may be selected from KHCO₃, KCl, and Na₂SO₄.

In the anode part 120, an ammonia oxidation reaction (AOR), in which ammonia (NH₃) is oxidized and decomposed into nitrogen (N₂) and water (H₂O), occurs. Preferably, water may be decomposed into protons (H⁺) and hydroxide ions (OH⁻) through water decomposition in the bipolar membrane 130, and thus the formed hydroxide ions (OH⁻) may be moved to the second electrolyte 122. The hydroxide ions (OH⁻) formed by the bipolar membrane 130 may move through the second electrolyte 122 and may react with ammonia to oxidize and decompose ammonia to generate nitrogen and water and emit electrons. Specifically, the AOR occurring in the anode part 120 may be as shown in Reaction Formula 4 below.

$$2 {NH}_{3} + 6 {OH}^{-} \to {N}_{2} + 6 {H}_{2} O + 6 {e}^{-} ( - 0.77 V vs . SHE ) \qquad [ Reaction Formula 4 ]$$

That is, in the anode part 120, ammonia (NH₃) reacts with hydroxide ions (OH⁻) to generate nitrogen (N₂) and water (H₂O) and emit electrons (e⁻). In order to discharge nitrogen (N₂) gas generated in the anode part 120, the hydrogen production system 100 of the present invention may further include a second outlet (not shown) connected to the anode part 120. Nitrogen gas may be discharged to the outside from the anode part 120 through the second outlet.

The anode part 120 includes the anode 121 (oxidation electrode). The anode 121 may include an AOR catalyst. As the AOR catalyst, any known catalyst for oxidizing and decomposing ammonia may be used, and the anode 121 may include, for example, at least one metal catalyst selected from platinum (Pt), iridium (Ir), rhodium (Rh), ruthenium (Ru), iron (Fe), cobalt (Co), nickel (Ni), and copper (Cu), but the present invention is not necessarily limited thereto. The anode 121 may have an arrangement in which one side thereof is in contact with the second electrolyte 122, but alternatively, the anode 121 may have an arrangement in which at least a portion of the anode 121 is immersed in the second electrolyte 122.

The anode part 120 includes the second electrolyte 122. The second electrolyte 122 may be alkaline and for example, may have a pH of 12 to 15, specifically a pH of 14 to 15. The second electrolyte 122 may be an aqueous electrolyte, specifically an alkaline aqueous electrolyte containing water. The second electrolyte 122 may further include other ammonia other than water. In addition, the second electrolyte 122 may further include electrolyte materials other than water and ammonia. Except that other electrolyte materials should be electrolyte materials that neutralize the pH of the second electrolyte 122, types of other electrolyte materials are not particularly limited, and any electrolyte material known in the art may be used. The electrolyte material may be, for example, an alkaline electrolyte material. For example, the electrolyte material may be an alkaline aqueous solution, in which at least one selected from alkali metal hydroxides (for example, LiOH, NaOH, and KOH) is dissolved in water, specifically an aqueous KOH solution.

According to one embodiment, the anode part 120, the anode part 120 and the cathode part 110, or the hydrogen production system 100 of the present invention may have a temperature of 30° C. or more, 40° C. or more, 45° C. or more, or 50° C. or more. For example, the temperature may range from 40° C. to 80° C., from 45° C. to 80° C., or from 45° C. to 70° C. In the above temperature range, current density may increase, which is regarded to be because rates of a hydrogen evolution reaction and an ammonia decomposition reaction are accelerated. When the temperature exceeds 80° C., a rate of a dissolution reaction of ammonia in water may be slow, and an amount of dissolution may be small, which may actually lower current density.

According to one embodiment, the second electrolyte 122 of the present invention may contain ammonia and an alkali metal hydroxide, and a concentration of the alkali metal hydroxide may be 1 M or more, 3 M or more, or 5 M or more, and for example, may be in a range of 1 M to 6 M. Since an anode reaction (AOR) that occurs at an anode is a reaction in which OH⁻ ions are used as reactants, the kinetics of an AOR seem to be improved as a concentration of an alkali metal hydroxide increases.

According to one embodiment, the second electrolyte 122 of the present invention may include ammonia and an alkali metal hydroxide, and a concentration of the ammonia may be in a range of 0.7 M to 1.3 M or 0.8 M to 1.2 M. When the concentration of ammonia is in such a range, side reactions forming metal oxynitrides do not easily occur, and electrochemical performance may be stably maintained.

The bipolar membrane 130 is disposed between the cathode part 110 and the anode part 120. The bipolar membrane 130 may be typically an ion exchange membrane having a form in which an anion exchange membrane and a cation exchange membrane are bonded and may decompose water into protons (H⁺) and hydroxide ions (OH⁻) when a voltage of a certain level or more is applied. According to one embodiment of the present invention, the bipolar membrane 130 may decompose water into protons (H⁺) and hydroxide ions (OH⁻) so that the formed protons (H⁺) may move to the first electrolyte 112, and the hydroxide ions (OH⁻) may move to the second electrolyte 122.

The bipolar membrane 130 is typically an ion exchange membrane in which an anion exchange membrane and a cation exchange membrane are bonded. The anion exchange membrane includes an ion exchange material that is substantially permeable to anions and substantially impermeable to cations, and the cation exchange membrane includes an ion exchange material that is substantially permeable to cations and substantially impermeable to anions. Examples of bipolar membranes that may be used in the present invention may include Fumasep FBM (product manufactured by The Fuel Cell Store).

The anion exchange membrane and the cation exchange membrane may be an anion-exchangeable polymer membrane and a cation-exchangeable polymer membrane. The anion-exchangeable polymer membrane or cation-exchangeable polymer membrane may have a form which includes a porous support including pores and an ion-exchangeable polymer filling the pores or may have a form which further includes an ion-exchangeable polymer layer on one surface or two surfaces of a porous support. In addition, the anion or cation-exchangeable polymer membrane may be manufactured by immersing a porous support in a polymer solution, filling internal pores of the porous support with a polymer, and then introducing an ion exchange group or may be manufactured by allowing a monomer having an ion exchange group to permeate into a porous support and then polymerizing the monomer.

A polymer used in the anion or cation-exchangeable polymer membrane is not particularly limited as long as the polymer is a known polymer having ion exchange capacity. An anion-exchangeable polymer may be prepared, for example, by polymerizing a styrene-based monomer (for example, styrene) and a vinylbenzene-based monomer (for example, divinylbenzene) and then introducing an anion exchange group (for example, a quaternary ammonium group). In addition, a cation-exchangeable polymer may be prepared, for example, by using a polymer such as polysulfone or polyetheretherketone and introducing a cation exchange group (for example, a sulfonic acid group) thereto.

Meanwhile, in order to increase water decomposition efficiency, a catalyst layer may be added to the bipolar membrane and used. In this case, the bipolar membrane has a form in which an anion exchange layer, a catalyst layer, and a cation exchange layer are stacked or may be used by forming and stacking a catalyst layer on two surfaces of each of an anion exchange layer and a cation exchange layer.

In the case of the conventional battery, a junction potential may be generated in a bipolar membrane due to a pH difference between a cathode and an anode. That is, it has been regarded that when the pH of an electrolyte of a cathode is set to neutral and the pH of an anode is set to alkaline, a junction potential due to a pH difference may be smaller as compared with when the pH of the cathode is acidic. Accordingly, it could be predicted that a hydrogen production system could operate spontaneously only when a junction potential was small, and it was difficult for the hydrogen production system to operate spontaneously when a junction potential was large.

Accordingly, in the case of the hydrogen production system according to one embodiment, since the pH of the first electrolyte of the cathode and the pH of the second electrolyte of the anode may be set to a specific range to respectively be neutral and alkaline, a junction potential may be more efficiently reduced, and thus a spontaneous reaction may occur, which may obtain an advantage in which the hydrogen production system may be more efficiently driven.

Specifically, a difference between the pH of the first electrolyte and the pH of the second electrolyte may be in a range of about 4 to 9, specifically about 6 to 9. For example, the pH of the first electrolyte may be in a range of pH 6 to pH 8, and the pH of the second electrolyte may be in a range of pH 12 to pH 15.

Accordingly, the hydrogen production system according to one embodiment may cause a spontaneous reaction in which a current density of more than 0 mA/cm² and less than or equal to 100 mA/cm² is generated at a cell potential ranging from 0 V to 0.6 V.

In summary, the hydrogen production system according to one embodiment can adjust a desired reaction according to an amount of oxygen at a cell potential ranging from 0 V to 0.6 V. Specifically, in a case in which only power production is required, when an amount of input oxygen is increased through the oxygen adjustment part, since a cell potential may be maintained in a normal range, a reaction as shown in Reaction Formula 3 above may occur in the cathode part to more efficiently produce power. In a case in which power production and hydrogen production are required, when an amount of input oxygen is reduced through the oxygen adjustment part, although a cell potential may be reduced to some extent for hydrogen production, a reaction as shown in Reaction Formula 2 above may occur at the cathode to produce hydrogen and power together.

Additionally, the hydrogen production system according to one embodiment has ab advantage in that a nonspontaneous reaction may also occur in which a current density exceeding 100 mA/cm² is generated through a water electrolysis reaction.

Meanwhile, in the hydrogen production system 100 of the present invention, an AOR at the anode part 120 may occur at a voltage of −0.6 V to −0.4 V with respect to a reference electrode of Ag/AgCl, and the following poisoning reaction occurs during the AOR.

$$Nads : - 0.5 V to - 0.4 V vs . Ag / AgCl$$

$$OHads : - 0.523 V vs . Ag / AgCl$$

That is, during the AOR, Nads and OHads are generated as intermediate products in a process in which ammonia is oxidized to produce N₂ and H₂O, and Nads and OHads are attached to an electrode and block active sites of the electrode, and thus a poisoning reaction inhibiting ammonia oxidation occurs. In addition, the performance of a system is degraded due to this poisoning.

Accordingly, according to another aspect of the present invention, as a method of stabilizing an electrode by removing poisoning from a poisoned electrode in the hydrogen production system 100, provided is a method including performing a cathodic scan in the hydrogen production system 100 which is a system that includes the cathode part 110 including the cathode 111 and the first aqueous electrolyte, the anode part 120 including the anode 121 and the second aqueous electrolyte 122, and the bipolar membrane 130 disposed between the cathode part 110 and the anode part 120, wherein a hydrogen evolution reaction occurs in the cathode part 110 and an AOR occurs in the anode part 120.

Since the above-described cathodic scan is performed in the anode part 120, a reduction reaction of the intermediate product generated during the AOR may occur to regenerate an active site of an electrode, thereby stabilizing a poisoned electrode to restore the performance of the system. The cathodic scan may be performed once, but may be repeated a plurality of times as needed. For example, the cathodic scan may be performed 2 times to 12 times, but the number of times is not limited thereto and may be appropriately selected according to a degree of poisoning. In addition, the cathodic scan may be performed for, for example, 1 minute to 7 minutes at a time. According to the present invention, the above-described poisoning can be removed to stabilize the electrode and restore the performance of the system performance. Thus, there is an advantage in that the system can be used for a long period of time.

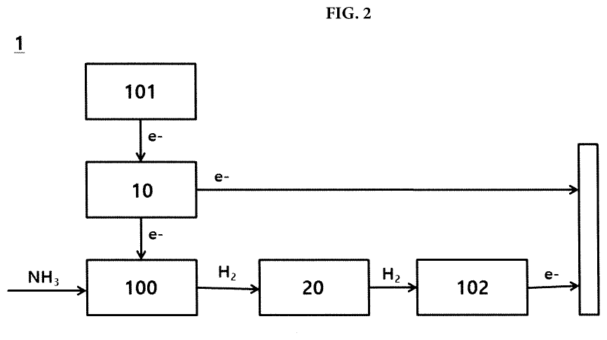

FIG. 2 is a schematic illustrating a combined power generation system 1 according to the present invention. Referring to FIG. 2, the combined power generation system 1 according to the present invention may include a renewable energy generation unit 101, an electric energy storage unit 10, a hydrogen production unit 100, a hydrogen storage unit 20, and a fuel cell 102. The hydrogen production unit may be the hydrogen production system 100 described above.

The renewable energy generation unit 101 is a generator that produces power from at least one type renewable energy source such as tidal power, wave power, wind power, geothermal heat, or solar power.

For example, the renewable energy generation unit 101 may be one type generator selected from a tidal power generation unit, a wave power generation unit, a wind power generation unit, a geothermal power generation unit, and a solar power generation unit or may be a hybrid power generation unit that produces power in combination by combining two or more types of renewable energy generation units. In the case of a hybrid renewable energy generation unit, the combined power generation system 1 may further include an energy converter that combines powers produced from respective power generation units into one, and a converter that is connected to the energy converter and converts power to supply power to the electric energy storage unit 10.

The electric energy storage unit 10 stores power generated from the renewable energy generation unit 101. The power stored in the storage unit 10 may be immediately supplied to consumers, or surplus stored energy remaining after the supply may be supplied to the hydrogen production unit 100 and used to produce hydrogen.

The hydrogen production unit 100 produces hydrogen using water electrolysis in a bipolar membrane and ammonia. Like the hydrogen production system 100 described above with reference to FIG. 1, the hydrogen production unit 100 may produce hydrogen through a spontaneous reaction without power supply. However, power produced from the renewable energy generation unit 101 is supplied to the hydrogen production unit 100 with or without passing through the electric energy storage unit 10, thereby consuming less energy to achieve higher hydrogen production efficiency. Power generated from the renewable energy generation unit 101 may be supplied during an initial operation of the hydrogen production unit 100 or may be continuously supplied during a hydrogen production process in addition to the initial operation.

The hydrogen storage unit 20 may store hydrogen produced in the hydrogen production unit 100 and may further include a compressor for compressing hydrogen up to high pressure. The hydrogen storage unit 20 may supply the stored hydrogen to the fuel cell 102. To this end, the hydrogen storage unit 20 may further include a controller capable of controlling an amount of supplied hydrogen.

The fuel cell 102 is a hydrogen fuel cell which generates water and electrical energy through a chemical reaction between hydrogen and oxygen. The hydrogen fuel cell may be at least one of a molten carbonate fuel cell (MCFC), a polymer electrolyte membrane fuel cell (PEMFC), a solid oxide fuel cell (SOFC), a phosphoric acid fuel cell (PAFC), and a direct carbon fuel cell (DCFC), but the present invention is not limited thereto. In the case of the present invention, the hydrogen fuel cell may be constructed as one system together with the hydrogen production unit 100 using ammonia to receive hydrogen gas generated from the hydrogen production unit 100 so that efficiency can be significantly improved.

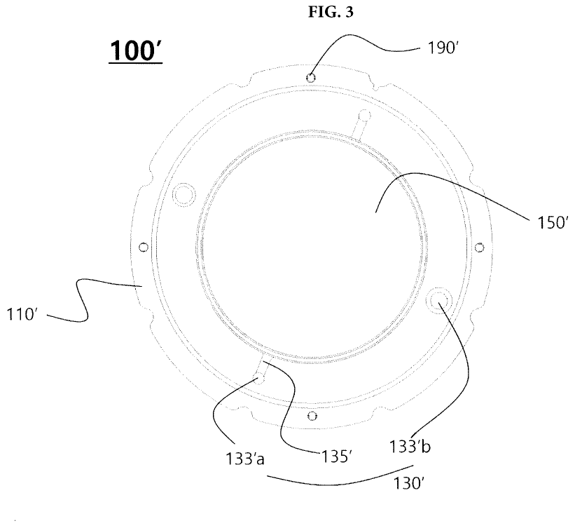

Meanwhile, FIG. 3 is a front view of a composite electrode separator.

Referring to FIG. 3, a composite electrode separator 100′ according to one embodiment includes a separation part 110′ having a plate shape, a transport part 130′ formed on two surfaces of the separation part and having a flow path 135′ through which a reactant and a product flow, and an input/output hole 133′ through which a reactant flow in and a product flows out, a reaction part 150′ having an area other than the transport portion formed on one surface or two surfaces, and an electrode part 170′ positioned in the reaction part and including a cathode, an anode, and a bipolar membrane disposed between the cathode and the anode. In this case, the electrode part may be the same system as the hydrogen production system 100 described above.

The separation part 110′ may serve as a support for the transport part for diffusing a gas-liquid of a reactant and a product and the reaction part for electrode reaction. A shape of the separator 110′ is not limited but may be a plate shape.

The separation part may include highly durable plastic, metal, or alloy to serve as the support for the transport part and the reaction part. Preferably, the separation part may include plastic with strong mechanical properties but low specific gravity and may include, for example, at least one selected from the group consisting of polytetrafluoroethylene (PTFE), an ethylene propylene diene terpolymer (EPDM), and composite polypropylene (PP).

The separation part may further include a guide groove 190′ at a side thereof. Since a separate guide member is fastened to the guide groove when a composite hydrogen production stack is assembled later, the guide groove may facilitate the assembly of a current collector plate, a composite electrode separator, and a fastening plate.

The transport part 130′ is formed on two surfaces of the separation part and has the input/output hole 133′ through which a reactant flow in and a product flows out, and the flow path 135′ through which a reactant and a product flow.

According to one embodiment, the transport part 130′ may include the input/output hole 133′ through which a reactant may flow into the electrode part and a product may be flow out of the electrode part. Preferably, the input/output hole may include a cathode input/output hole 133′a and an anode input/output hole 133′b.

According to one embodiment, the cathode input/output hole 133′a may be formed at one side of the transport part, and the same cathode input/output hole 133′a may also be formed at the other side thereof. Accordingly, an electrolyte and oxygen gas which are reactants may flow in through one surface of the cathode input/output hole, and an electrolyte including hydroxide ions and hydrogen gas, which are products, may flow out through the other surface of the cathode input/output hole.

The cathode input/output hole 133′a may further include an oxygen adjustment part that adjusts an amount of oxygen of a reactant flowing into the electrode part. Oxygen may be adjusted through the oxygen adjustment part to adjust of a reaction at the cathode.

According to one embodiment, the anode input/output hole 133′b may be formed at one side corresponding to the cathode input/output hole 133′a, and the anode input/output hole 133′b may also be formed at the other side to correspond to the cathode input/output hole 133′a. Accordingly, an electrolyte including ammonia and hydroxide ions, which are reactants, may flow in through one surface of the anode input/output hole, and an electrolyte and nitrogen gas, which are products, may flow out through the other surface of the anode input/output hole.

According to one embodiment, the flow path 135′ may be connected to the cathode input/output hole 133′a and the anode input/output hole 133′b and may serve to allow an electrolyte and oxygen gas, which are reactants flowing in through one surface of the cathode input/output hole, to flow into the cathode in the electrode part, allow an electrolyte including ammonia and hydroxide ions, which are reactants flowing in through one surface of the anode input/output hole, to flow into the electrode part, allow hydrogen gas and an electrolyte including hydroxide ions, which are products flowing out through the other surface of the cathode input/output hole, to flow, and allow an electrolyte and nitrogen gas, which are products flowing out through the other surface of the anode input/output hole, to flow.

The transport part may be formed in a concave shape on two surfaces of the separation part. Specifically, the transport part may be formed in the separation part through machining, chemical etching, or electrochemical etching.

Specifically, the transport part may be formed through machining center (MCT) processing or etching. The transport part may be formed to be engraved in a vertical direction from the surface of the separation part.

A depth of the transport part engraved from the surface of the separation part is not limited as long as the transport part may serve as a passage, and preferably, the transport part may be formed to have a depth of 1 mm or less.

A type of an electrolyte flowing into the reaction part may vary according to the electrode of the electrode part, and the transport part may additionally include an oxygen adjustment part. Specifically, a reactant flowing in through the cathode input/output hole may include a neutral electrolyte.

For example, a hydrogen ion concentration of an electrolyte included in the reactant flowing in through the cathode input/output hole may be in a range of pH 6 to pH 8, preferably, about pH 7.

The electrolyte included in the reactant flowing in through the cathode input/output hole may be an aqueous electrolyte, specifically an aqueous electrolyte containing water. The electrolyte may further include other electrolyte materials other than water. Except that other electrolyte materials should be electrolyte materials that neutralize the pH of the electrolyte, types of other electrolyte materials other than water are not particularly limited, and any electrolyte material known in the art may be used. The electrolyte material may be, for example, a neutral electrolyte material, and for example may be include at least one selected from KHCO₃, KCl, and Na₂SO₄.

Meanwhile, the reactant flowing in through the anode input/output hole may include a basic electrolyte. For example, a hydrogen ion concentration of an electrolyte included in the reactant flowing in through the anode input/output hole may be in a range of pH 12 to pH 15, preferably, in a range of about pH 14 to pH 15.

The electrolyte included in the reactant flowing in through the anode input/output hole may be an aqueous electrolyte, specifically an aqueous electrolyte containing water. The electrolyte may further include ammonia in addition to water and may further include electrolyte materials other than water and ammonia. Except that other electrolyte materials should be electrolyte materials that neutralize the pH of the electrolyte, types of other electrolyte materials are not particularly limited, and any electrolyte material known in the art may be used.

The electrolyte material may be, for example, an alkaline electrolyte material. For example, the electrolyte material may be an alkaline aqueous solution, in which at least one selected from alkali metal hydroxides (for example, LiOH, NaOH, and KOH) is dissolved in water, specifically an aqueous KOH solution.

The reaction part 150′ is not particularly limited as long as the reaction part 150′ has an area other than the transport part and provides a space in which the electrode part may be formed.

The reaction part may communicate through the flow path 135′ in the transport part in order for the electrode part to transport a reactant flowing in for electrode reaction and a product flowing out.

According to one embodiment, the reaction part may have an empty space or an empty area to provide a space in which the electrode part may be formed.

The electrode part 170′ (not shown) is formed in the area of the reaction part.

According to one embodiment, the electrode part may be positioned in the reaction part, may include the cathode and the anode, and preferably may also include the bipolar membrane positioned between the cathode and the anode.

The electrode part may have a porous structure to diffuse generated gas and dissipate heat. In order to form the porous structure, the electrode part may be formed through electrochemical plating, spray coating, physical vapor deposition (PVD), thermal spray coating, or hydrothermal synthesis using a titanium mesh (Ti mesh), nickel foam (Ni foam), or the like.

Accordingly, the electrode part may have a specific surface area of 5 m²/g to 100 m²/g and a pore size of 0.02 μm to 12 μm. When the specific surface area is out of such a range and is too small or the pore size is out of such a range and is large, there is a disadvantage in that the dispersion of a catalyst is lowered and the overall active area of the catalyst is reduced, resulting in low catalytic activity. In addition, when the specific surface area is too large or the pore size is too small, there is a disadvantaged in that electrolyte transfer is limited, which reduces a reaction rate.

Specifically, the cathode included in the electrode part may be a reduction electrode. The cathode is not particularly limited as long as the cathode includes a material capable of reducing electrons at the cathode. The cathode may include at least one selected from the group consisting of a metal foam, a metal thin film, carbon paper, carbon fiber, carbon felt, and carbon cloth.

In addition, a catalyst may be further included in the cathode to promote a reduction reaction of the cathode. Specifically, when a concentration of oxygen dissolved in an electrolyte flowing into the cathode is low, the cathode may include a hydrogen evolution reaction catalyst, but even when a concentration of oxygen dissolved in an electrolyte flowing into the cathode is high, the cathode may include the hydrogen evolution reaction catalyst. For example, the hydrogen evolution reaction catalyst may include at least one catalyst selected from the group consisting of platinum (Pt), iridium (Ir), rhodium (Rh), ruthenium (Ru), iron (Fe), cobalt (Co), nickel (Ni), and copper (Cu), but the present invention is not limited to only specific types.

In addition, the anode included in the electrode part may be an oxidization electrode and is not particularly limited as long as the anode includes an AOR catalyst.

As the AOR catalyst that may be included in the anode, any known catalyst for oxidizing and decomposing ammonia may be used, and the anode may include, for example, at least one metal catalyst selected from platinum (Pt), iridium (Ir), rhodium (Rh), ruthenium (Ru), iron (Fe), cobalt (Co), nickel (Ni), and copper (Cu), but the present invention is necessarily limited thereto.

According to one embodiment, the composite electrode separator may be a composite gasket including a cathode, an anode, and a membrane.

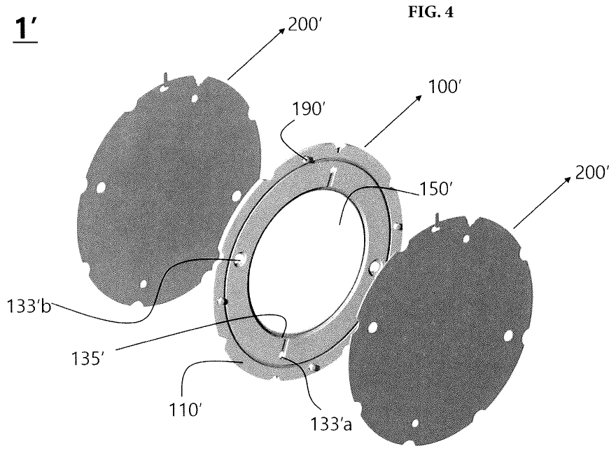

FIG. 4 is an exploded view of a composite hydrogen production stack including a composite electrode separator.

Referring to FIG. 4, the composite hydrogen production stack according to another embodiment may include one or more unit cells each including a composite electrode separator and current collector plates positioned on two surfaces of the electrode separator.

According to one embodiment, a composite hydrogen production stack 1′ may include one unit cell including a composite electrode separator 100′, and current collector plates 200′ positioned on two surfaces of the electrode separator.

In portions of the current collector plate corresponding to a cathode input/output hole 133′a and an anode input/output hole 133′b, holes may be formed in sizes corresponding to the cathode input/output hole 133′a and the anode input/output hole 133′b, and preferably, for coupling, a hole may be formed in a portion corresponding to a guide groove 190′ to have a size that facilitates coupling.

According to one embodiment, the composite hydrogen production stack may include end plates provided at both sides thereof and may have a structure including two unit cells formed by sequentially stacking a fastening plate, a current collector plate, a composite electrode separator, a current collector plate, a composite electrode separator, a current collector plate, and a fastening plate from one side to the other side. In addition, a structure including three or more unit cells may be manufactured by repeating the above structure. The number of unit cells may be adjusted in various ways according to the purpose of use, and the present invention is not particularly limited.

Each component of the composite hydrogen production stack may be assembled and fastened through a guide member and a corresponding groove of a current collector, which may make it easy to assemble the composite hydrogen production stack.

That is, since the composite hydrogen production stack satisfying such a configuration includes a composite electrode separator for hydrogen production in which a plurality of components of an electrode, a gas-liquid diffusion layer, and a separator are integrated into one component, the number of parts applied to the composite hydrogen production stack can be reduced to simplify stack assembly, reduce a stack volume, and also reduce electrolyte resistance, and thus operating current density can be increased, thereby obtaining an advantage in that high-efficiency and high-current operation is possible.

In addition, the composite hydrogen production stack that satisfies the above configuration is an electrochemical system in which a spontaneous electrochemical potential is generated. A concentration of oxygen may be adjusted to adjust a cell potential and generate hydrogen (H₂) as needed, and the generated hydrogen may be used as a fuel for other fuel cells and introduced into a composite fuel cell system.

Specifically, when the composite hydrogen production stack operates, hydrogen may be produced through a hydrogen evolution reaction as shown in Reaction Formula 1 above by a bipolar membrane. In this case, an oxygen adjustment part included in a cathode input/output hole may adjust an amount of oxygen to enable hydrogen gas and power to be additionally produced together or enable only power to be produced.

As an example, when an amount of oxygen of a reactant flowing into the cathode is reduced through the oxygen adjustment part, and thus a concentration of oxygen included in the reactant flowing in through the cathode input/output hole is low, is preferably 12% or less, or is more preferably in a range of more than 0% and 12% or less, electrons of the cathode may react with water (H₂O) to generate hydrogen (H₂). That is, when a concentration of oxygen dissolved in an electrolyte is low, a reaction may occur as shown in Reaction Formula 2 above. As a result, in a case in which the composite hydrogen production stack needs to produce power and hydrogen, when an amount of input oxygen is reduced through the oxygen adjustment part, a cell potential may be reduced to some extent for hydrogen production, but a reaction as shown in Reaction Formula 2 above occurs at the cathode, thereby producing hydrogen and power together.

Meanwhile, when an amount of oxygen in a reactant flowing into the cathode is increased through the oxygen adjustment part, and thus the concentration of oxygen included in the reactant flowing in through the cathode input/output hole is high, is preferably more than 12%, or is more preferably more than 12% and less than 100%, an oxygen reduction reaction may occur in which electrons of the cathode react with water (H₂O) and oxygen (O₂) to generate hydroxide ions (OH⁻). That is, when a concentration of oxygen dissolved in an electrolyte is high, a reaction may occur as shown in Reaction Formula 3 above.

As a result, in a case in which the composite hydrogen production stack needs to produce only power, when an amount of oxygen input is increased through the oxygen adjustment part, a cell potential may be maintained in a normal range, and thus a reaction as shown in Reaction Formula 2 may occur in the cathode part to more efficiently produce power.

At the anode included in the electrode part, an AOR may occur in which ammonia (NH₃) is oxidized and decomposed into nitrogen (N₂) and water (H₂O).

The AOR that occurs at the anode may occur as shown in Reaction Formula 4 above.

That is, at the anode, ammonia (NH₃) may be oxidized through a reaction with hydroxide ions (OH⁻) to generate nitrogen (N₂) and water (H₂O) and emit electrons (e⁻).

The membrane may be a bipolar membrane in which one surface thereof includes a cation exchange membrane having a cation exchange group, and the other surface of the membrane includes an anion exchange membrane having an anion exchange group. When a voltage is applied to the bipolar membrane, water may be dissociated at each of on both sides of the membrane so that OH⁻ ions may be generated in the anion exchange membrane and H+ ions may be generated in the cation exchange membrane. When the membrane with such characteristics is installed between a cathode and an anode, gases or solutions generated at the cathode and anode may be blocked from being mixed, and also the pH of electrolytes at both sides may be maintained. In addition, when a bipolar membrane is used as the membrane, a hydrogen evolution reaction may additionally occur through a water dissociation reaction.

In the case of a conventional battery, a junction potential may be generated in a bipolar membrane due to a pH difference between composite electrode separators of a cathode. That is, it has been regarded that when the pH of an electrolyte of a cathode is set to neutral and the pH of an anode is set to alkaline, a junction potential due to a pH difference may be smaller as compared with when the pH of the cathode is acidic. Accordingly, it could be predicted that a stack system could operate spontaneously only when a junction potential was small, and it was difficult for the stack system to operate spontaneously when a junction potential was large.

Accordingly, in the case of the composite hydrogen production stack according to one embodiment, similar to the above-described hydrogen production system, the pH of an electrolyte included in a reactant flowing in through the cathode input/output hole of the composite electrode separator and the pH of an electrolyte included in a reactant flowing in through an anode input/output hole may be set to a specific range to respectively be neutral and alkaline to more efficiently reduce a junction potential, and thus a spontaneous reaction may occur, thereby obtaining an advantage in that a hydrogen production system may be more efficiently driven.

Specifically, when the pH of the electrolyte included in the reactant flowing in through the cathode input/output hole is set to neutral and the pH of the electrolyte included in the reactant flowing in through the anode input/output hole is set to alkaline, a difference between the pH of the electrolyte included in the reactant flowing in through the cathode input/output hole and the pH of the electrolyte included in the reactant flowing in through the anode input/output hole may be in a range of about 4 to 9, specifically in a range of about 6 to 9. For example, the pH of the electrolyte included in the reactant flowing in through the cathode input/output hole may be in a range of pH 6 to pH 8, and the pH of the electrolyte included in the reactant flowing in through the anode input/output hole may be in a range of pH 12 to pH 15.

Accordingly, the composite hydrogen production stack according to one embodiment may cause a spontaneous reaction in which a current density of more than 0 mA/cm² and less than or equal to 100 mA/cm² is generated at a cell potential ranging from 0 V to 0.6 V.

In summary, the composite hydrogen production stack according to one embodiment can adjust a desired reaction according to an amount of oxygen at a cell potential ranging from 0 V to 0.6 V. Specifically, in a case in which only power production is required, when an amount of input oxygen is increased through the oxygen adjustment part, since a cell potential may be maintained in a normal range, a reaction as shown in Reaction Formula 3 above may occur in the cathode part to more efficiently produce power. In a case in which power production and hydrogen production are required, when an amount of input oxygen is reduced through the oxygen adjustment part, although a cell potential may be reduced to some extent for hydrogen production, there is an advantage in that a reaction as shown in Reaction Formula 2 above may occur at the cathode to produce hydrogen and power together.

In addition, the composite hydrogen production stack according to one embodiment may have an advantage in that a nonspontaneous reaction may occur in which a current density exceeding 100 mA/cm² is generated through a water electrolysis reaction.

In addition, according to still another embodiment, similar to the above-described hydrogen production system, there may be additionally provided a combined power generation system including a hydrogen fuel cell receiving hydrogen discharged from the composite hydrogen production stack.

The hydrogen fuel cell may produce water through a chemical reaction between hydrogen and oxygen and also generate electrical energy. Specifically, the hydrogen fuel cell may be an SOFC.

Conventionally, hydrogen fuel cells have many advantages in terms of environmental friendliness, but should receive hydrogen extracted through methane-steam reforming. However, in the combined power generation system according to still another embodiment, since the hydrogen fuel cell and the composite hydrogen production stack are constructed as one system, hydrogen gas generated from the composite hydrogen production stack is received as a fuel, thereby considerably improving efficiency.

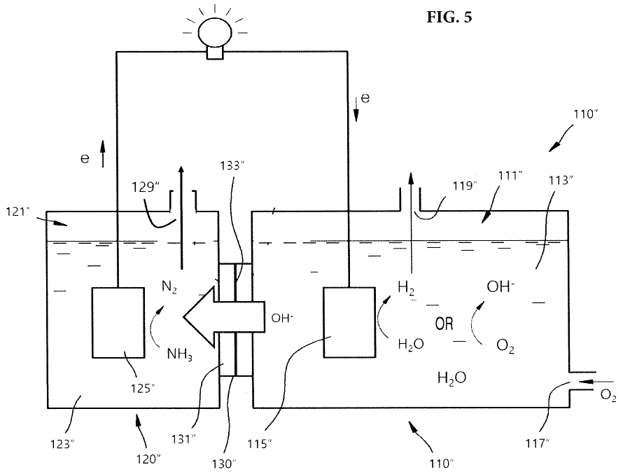

FIG. 5 is a schematic view illustrating an ammonia fuel cell system 100″ according to one implementation. Referring to FIG. 5, a cathode part 110″ includes a first electrolyte 113″ accommodated in a first accommodation space 111″, and a cathode″ of which at least a portion is submerged in the first electrolyte 113″, an anode part 120″ includes a second electrolyte 123″ accommodated in a second accommodation space 121″, and a metal anode 125″ of which at least a portion is submerged in the second electrolyte 123″, and a connection part 130″ includes a connection passage 131″ for allowing the first accommodation space 111″ to communicate with the second accommodation space 121″, and an anion exchange membrane 133″ provided in the connection passage to allow anions to move.

The cathode part 110″ may include the first electrolyte 113″ accommodated in the first accommodation space 111″, and the cathode 115″ of which at least a portion is submerged in the first electrolyte.

Preferably, the cathode part 110″ may further include an oxygen adjustment part 117″ connected to the first accommodation space 111″ of the cathode part 110″ to adjust an amount of oxygen input to the first accommodation space 111″.

A reaction, in which hydrogen is generated or not generated according to whether a concentration of oxygen dissolved in the first electrolyte is high or low, may occur in the cathode part.

Specifically, an amount of oxygen input to the first accommodation space may be reduced through the oxygen adjustment part, and thus when a concentration of oxygen dissolved in the first electrolyte in the cathode part is low, is preferably 12% or less, or is more preferably more than 0% and 12% or less, electrons in the cathode part may react with water (H₂O) to generate hydrogen (H₂). That is, when a concentration of oxygen dissolved in the first electrolyte in the cathode part is low, a hydrogen evolution reaction may occur as shown in Reaction Formula 5 below.

$$2 {H}_{2} O + 2 {e}^{-} \to {H}_{2} + 2 {OH}^{-} \qquad [ Reaction Formula 5 ]$$

As a result, in a case in which an ammonia fuel cell needs to produce power and hydrogen, when an amount of input oxygen is reduced through the oxygen adjustment part, although a cell potential to be described below may be reduced to some extent for hydrogen production, a reaction as shown in Reaction Formula 5 above occurs in the cathode part, thereby producing hydrogen and power together.

Accordingly, since hydrogen gas may be generated, the cathode part 110 may additionally include a first outlet 119″ connected to the first accommodation space 111″ to discharge the generated hydrogen gas. Hydrogen gas may be discharged to the outside from the cathode part 110″ through the first outlet 119″.

In this case, positions of the oxygen adjustment part 117″ and the first outlet 119″ are not particularly limited as long as the oxygen adjustment part 117″ and the first outlet 119″ may be connected to the first accommodation space 111″ to function as described above. However, the oxygen adjustment part may be in contact with the first electrolyte to input oxygen, and the first outlet should discharge hydrogen gas so that it is preferable that the first outlet be disposed at an upper portion of the first accommodation space that is not in contact with the first electrolyte, and the oxygen adjustment part be disposed at a lower portion of the first accommodation space that is in contact with the first electrolyte.

Meanwhile, an amount of oxygen input to the first accommodation space may be increased through the oxygen adjustment part, and thus when a concentration of oxygen dissolved in the first electrolyte in the cathode part is high, is preferably more than 12%, or is more preferably more than 12% and less than 100%, electrons in the cathode part may undergo an oxygen reduction reaction with water (H₂O) and oxygen (O₂) to generate hydroxide ions (OH⁻). That is, when a concentration of oxygen dissolved in the first electrolyte in the cathode part is high, an oxygen reduction reaction may occur as shown in Reaction Formula 6 below.

$${O}_{2} + 2 {H}_{2} O + 4 {e}^{-} \to 4 {OH}^{-} \qquad [ Reaction Formula 6 ]$$

As a result, in a case in which the ammonia fuel cell needs to produce only power, when an amount of input oxygen is increased through the oxygen adjustment part, a cell potential to be described below may be maintained in a normal range, thereby obtaining an advantage in that a reaction as shown in Reaction Formula 6 may occur in the cathode part to more efficiently produce power.

The first electrolyte 113″ included in the cathode part 110″ may be neutral. For example, a hydrogen ion concentration of the first electrolyte may be in a range of pH 6 to pH 8 and preferably may be about pH 7.

The first electrolyte may be an aqueous electrolyte, specifically an aqueous electrolyte containing water. The first electrolyte may further include other electrolyte materials other than water. Except that other electrolyte materials should be electrolyte materials that neutralize the pH of the first electrolyte, types of other electrolyte materials other than water are not particularly limited, and any electrolyte material known in the art may be used. The electrolyte material may be, for example, a neutral electrolyte material, and for example may be include at least one selected from KHCO₃, KCl, and Na₂SO₄.

The cathode part 110″ may include the cathode 115″. The cathode may have an arrangement in which one side thereof is in contact with the first electrolyte, but preferably, the cathode may be positioned such that at least a portion of the cathode is submerged in the first electrolyte. The cathode may be a reduction electrode and is not particularly limited as long as the cathode includes a material capable of generating a reduction reaction at the cathode. The cathode may include at least one selected from the group consisting of a metal foam, a metal thin film, carbon paper, carbon fiber, carbon felt, carbon cloth, and a platinum catalyst, but the present invention is not limited thereto.

In addition, a catalyst may be further included in the cathode to promote a reduction reaction of the cathode. Specifically, when a concentration of oxygen dissolved in the first electrolyte flowing into the cathode part is low, the cathode may include a hydrogen evolution reaction catalyst, but even when a concentration of oxygen dissolved in the first electrolyte flowing into the cathode part is high, the cathode may include the hydrogen evolution reaction catalyst. For example, the hydrogen evolution reaction catalyst may include at least one catalyst selected from the group consisting of platinum (Pt), iridium (Ir), rhodium (Rh), ruthenium (Ru), iron (Fe), cobalt (Co), nickel (Ni), and copper (Cu).

The anode part 120″ may include the second electrolyte 123″ accommodated in the second accommodation space 121″, and the metal anode 125 of which at least a portion is submerged in the second electrolyte 123″.

In the anode part 120″, an AOR may occur in which ammonia (NH₃) is oxidized and decomposed into nitrogen (N₂) and water (H₂O).

The AOR occurring in the anode part may be as shown in Reaction Formula 7 below.

$$2 {NH}_{3} + 6 {OH}^{-} \to {N}_{2} + 6 {H}_{2} O + 6 {e}^{-} \qquad [ Reaction Formula 7 ]$$

That is, in the anode part, ammonia (NH₃) may be oxidized through a reaction with hydroxide ions (OH⁻) to generate nitrogen (N₂) and water (H₂O) and emit electrons (e⁻).

Accordingly, the anode part 120″ may additionally include a second outlet 129″ connected to the second accommodation space 121″ in the anode part 120″ to discharge generated nitrogen (N₂) gas. Nitrogen gas may be discharged to the outside from the anode part 120″ through the second outlet.

The anode part 120″ may include the second electrolyte 123″. The second electrolyte may be alkaline and preferably may include ammonia (NH₃) to be alkaline. A hydrogen ion concentration of the second electrolyte may be in the range of pH 12 to pH 15 and preferably may be in a range of about pH 14 to pH 15.

The second electrolyte may be an aqueous electrolyte, specifically an aqueous electrolyte containing water. The second electrolyte may further include ammonia other than water and may further include other electrolyte materials other than water and ammonia. Except that other electrolyte materials should be electrolyte materials that neutralize the pH of the second electrolyte, types of other electrolyte materials are not particularly limited, and any electrolyte material known in the art may be used.

The electrolyte material may be, for example, an alkaline electrolyte material. For example, the electrolyte material may be an alkaline aqueous solution, in which at least one selected from alkali metal hydroxides (for example, LiOH, NaOH, and KOH) is dissolved in water, specifically an aqueous KOH solution.

The anode part 120″ may include the anode 125″ which is an electrode. The anode may have an arrangement in which one side thereof is in contact with the second electrolyte, but preferably, the anode may be positioned such that at least a portion thereof is submerged in the second electrolyte.

The anode may be an oxidization electrode and is not particularly limited as long as the anode includes an AOR catalyst.

As the AOR catalyst that may be included in the anode, any known catalyst for oxidizing and decomposing ammonia may be used, and the anode may include, for example, at least one metal catalyst selected from platinum (Pt), iridium (Ir), rhodium (Rh), ruthenium (Ru), iron (Fe), cobalt (Co), nickel (Ni), and copper (Cu), but the present invention is necessarily limited thereto.

The connection part 130″ may include the connection passage 131″ for allowing the first accommodation space 111″ to communicate with the second accommodation space 121″; and the anion exchange membrane 133″ provided in the connection passage.

The connection passage may extend between a first connector formed in the cathode part and a second connector formed in the anode part and thus may allow the first accommodation space in the cathode part to communicate with the second accommodation space in the anode part.

The anion exchange membrane may be provided in the connection passage. Specifically, the anion exchange membrane may be provided in a form that blocks the interior of the connection passage.

The anion exchange membrane may only allow movement of ions between the cathode part and the anode part, and preferably, hydroxide ions (OH⁻) included in a first aqueous solution may move to a second aqueous solution through the anion exchange membrane.

Therefore, the anion exchange membrane is not particularly limited as long as the anion exchange membrane includes a material capable of moving hydroxide ions (OH⁻) included in the first aqueous solution to the second aqueous solution. For example, the anion exchange membrane may be an anion exchange membrane including a positively charged fixed-ion group that repels positively charged ions and does not allow the positively charged ions to pass therethrough, but allows negatively charged ions to selectively pass therethrough. According to one embodiment, the anion exchange membrane may be an anion exchange membrane including fixed-ions such as —NR₃⁺ (R: alkyl group), —NH₄⁺, and the like. Hydroxide ions (OH⁻) are transferred from the cathode part to the anode part through the anion exchange membrane, thereby resolving an ion imbalance that may occur during the operation of a fuel cell.

In addition, the anion exchange membrane may be further subjected to a certain process and then provided in the connection passage. Specifically, the anion exchange membrane may be pretreated in an alkaline environment, preferably under conditions of KOH or NaOH at 0.1 M to 1 M.

Through the pretreatment, a functional group in which cations are present as fixed-charges may be structurally formed on a pore wall present in the anion exchange membrane, and thus, since a state, in which the cations are weakly composite with anions passing through the anion exchange membrane and separated therefrom again and then are composite with the functional group again, is continuously repeated, as a result, there is an advantage in that only the anions may be allowed to more effectively pass through the anion exchange membrane, resulting in a better anion permeability effect.

In the ammonia fuel cell according to one embodiment, a junction potential may be generated in the anion exchange membrane due to a pH difference between the first electrolyte in the cathode part and the second electrolyte in the anode part.

In the case of a conventional battery, a junction potential may be generated in a bipolar membrane due to a pH difference between composite electrode separators of a cathode. That is, it has been regarded that when the pH of an electrolyte of a cathode is set to neutral and the pH of an anode is set to alkaline, a junction potential due to a pH difference may be smaller as compared with when the pH of the cathode is acidic. Accordingly, it could be predicted that a stack system could operate spontaneously only when a junction potential was small, and it was difficult for the stack system to operate spontaneously when a junction potential was large.

In the ammonia fuel cell according to one embodiment, in a case in which the pH of the electrolyte in the cathode part is set to neutral and the pH in the anode part is set to alkaline, rather, when a junction potential is small, a spontaneous reaction may occur, and thus a fuel cell system may be more efficiently driven.

Specifically, when the pH of the electrolyte in the cathode part is set to neutral and the pH in the anode part is set to alkaline, a difference between the pH of the first electrolyte in the cathode part and the pH of the second electrolyte in the anode part may be in a range of about 4 to 9, specifically, in a range of about 6 to 9. For example, the pH of the first electrolyte 112″ may be in a range of pH 6 to pH 8, and the pH of the second electrolyte 122″ may be in a range of pH 12 to pH 15.

Accordingly, the ammonia fuel cell according to one embodiment may exhibit a current density of more than 0 mA/cm² to 50 mA/cm² or less at a cell potential ranging from 0 V to 1.0 V.

Accordingly, since an AOR may continue spontaneously and power may be efficiently produced, in a case in which the ammonia fuel cell needs to produce only power, when an amount of input oxygen is increased through the oxygen adjustment part, a cell potential may be maintained in a normal range, and thus there may be an advantage in that a reaction shown in Reaction Formula 6 may occur in the cathode part to more efficiently produce power. In a case in which the ammonia fuel cell needs to produce power and hydrogen, when an amount of input oxygen is reduced through the oxygen adjustment part, although a cell potential to be described below may be reduced to some extent for hydrogen production, a reaction as shown in Reaction Formula 5 above occurs in the cathode part, thereby obtaining an advantage in that hydrogen and power are produced together.

Meanwhile, according to still another embodiment, there may be additionally provided a combined power generation system including a hydrogen fuel cell which finally receives discharged hydrogen by, when the above-described ammonia fuel cell system needs to produce hydrogen as well as power, reducing an amount of input oxygen through the oxygen adjustment part.

The hydrogen fuel cell may produce water through a chemical reaction between hydrogen and oxygen and also generate electrical energy. Specifically, the hydrogen fuel cell may be an SOFC.

Conventionally, hydrogen fuel cells have many advantages in terms of environmental friendliness, but should receive hydrogen extracted through methane-steam reforming. However, in the combined power generation system according to still another embodiment, since the hydrogen fuel cell and the ammonia fuel cell are constructed as one system, hydrogen gas generated from the ammonia fuel cell is received as a fuel, thereby considerably improving efficiency.

### MODE FOR CARRYING OUT THE INVENTION

Hereinafter, the present invention will be described in detail with reference to examples.

### Example 1—Manufacturing of Hydrogen Production System and Measurement of Cell Potential

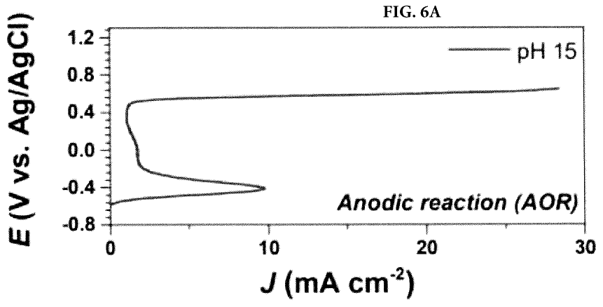

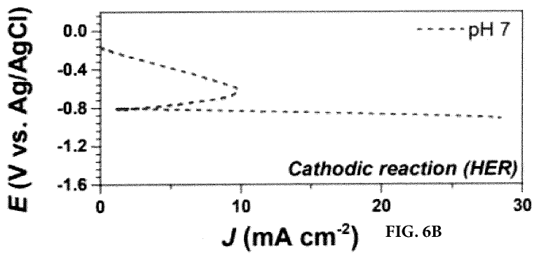

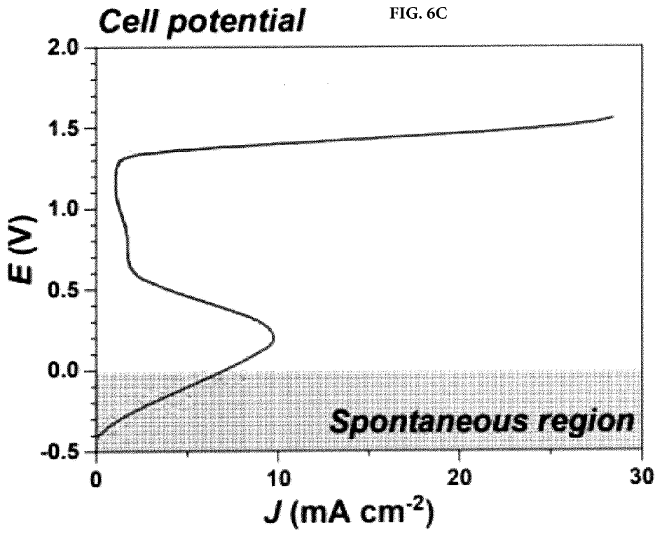

A 1 M KHCO₃ aqueous solution was used as a first electrolyte in a cathode part to adjust pH to 7, a 1 M NH₃ aqueous solution and a 5 M KOH aqueous solution were used as a second electrolyte in an anode part to adjust pH to 15, and Fumasep FBM (product manufactured by The Fuel Cell Store) was used as a bipolar membrane to manufacture a hydrogen production system according to the present invention. A potential in the anode part, a potential in the cathode part, and a cell potential were measured using Ag/AgCl as a reference electrode. Measurement results are shown in FIGS. 6A, 6B, and 6C, respectively. Referring to FIGS. 6A and 6B, it can be seen that a difference between the potential in the anode part (see FIG. 6A) and the potential in the cathode (see FIG. 6B) is small. In addition, as can be seen in FIG. 6C, it could be seen that a spontaneous reaction occurred while the consumption of cell potential was reduced.

### Example 2—Electrochemical Properties in Hydrogen Production System (Hydrogen Production Unit of Combined Power Generation System)

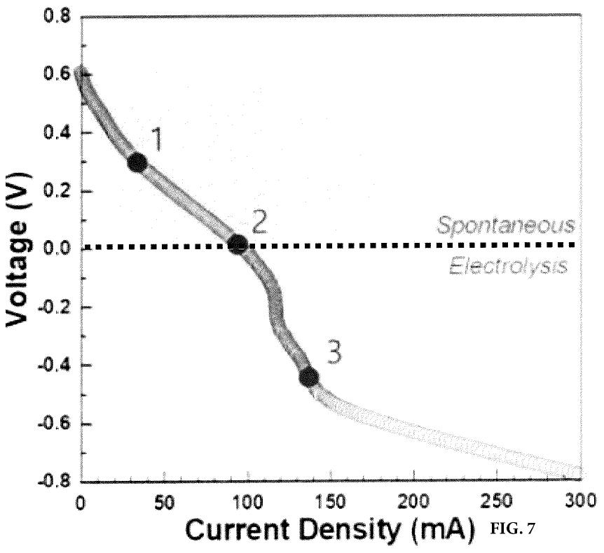

A 1 M KHCO₃ aqueous solution was used as a first electrolyte in a cathode part to adjust pH to 7, a 1 M NH₃ aqueous solution and a 5 M KOH aqueous solution were used as a second electrolyte in an anode part to adjust pH to 15, and Fumasep FBM (product manufactured by The Fuel Cell Store) was used as a bipolar membrane to manufacture a hydrogen production unit, that is, a hydrogen production system. Power was supplied to a cathode under the assumption that the power was received from a renewable energy generation unit, and a voltage according to a current density was measured in the hydrogen production unit and shown in FIG. 7. In FIG. 7, point 1 indicates a spontaneous reaction region in which a current flows without power supply, and point 2 indicates a spontaneous reaction region in which hydrogen production is maximum. Point 3 indicates a point at which water electrolysis occurs with ⅓ of energy consumed in typical water electrolysis. That is, according to the present invention, hydrogen is produced even at points 2 and 3 in FIG. 7, and it can be seen that a large amount of hydrogen may be produced with considerably lower energy than a water electrolysis technology according to a related art.

### Example 3—Optimal Temperature Operating Conditions in Hydrogen Production System

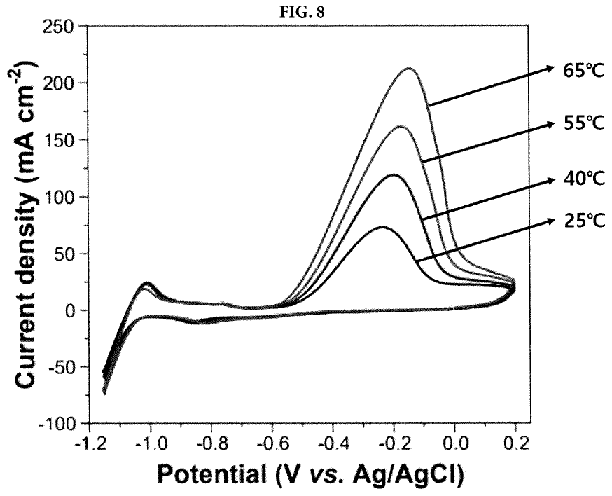

The same hydrogen production system as in Example 1 was manufactured, and electrochemical properties in an anode part were measured by changing a temperature of the hydrogen production system, including the anode part. Measurement results are shown in FIG. 8. Referring to FIG. 8, in the case of data measured at room temperature, a maximum current density was about 70 mA/cm², but when a temperature rose to 65° C., it could be observed that a maximum current density was about 210 mA/cm², and thus performance was increased to twice or more. Such improvement in performance according to a temperature appears because rates of a hydrogen evolution reaction and an ammonia decomposition reaction are accelerated as a temperature rises. However, at a temperature of 80° C., a dissolution reaction rate of ammonia in water was slow and an amount of dissolution was small, and thus performance rather decreased. According to results of the present experiment, an experiment temperature of the entire cell, including a cathode part and the anode part, was optimized to 65° C.

### Example 4—Optimal Electrolyte Concentration Conditions in Hydrogen Production System

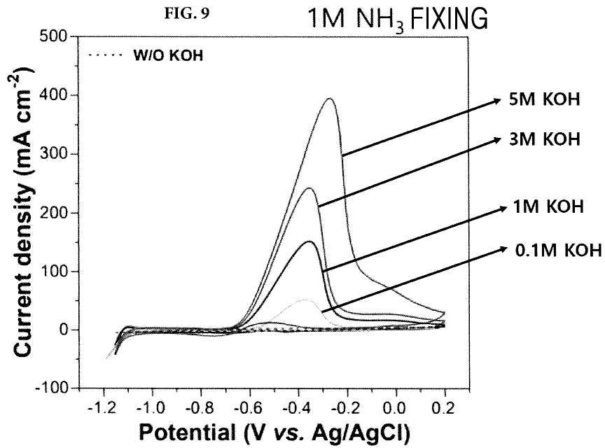

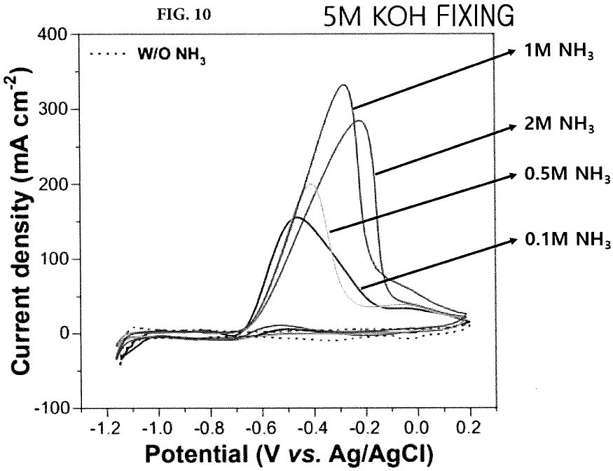

The same hydrogen production system as in Example 1 was manufactured, and electrochemical properties were measured by changing each a concentration of alkali metal hydroxide (KOH) and a concentration of ammonia in a second electrolyte of an anode part. Results thereof are shown in FIGS. 9 and 10, respectively.

Referring to FIG. 9, it can be seen that current density increases as the concentration of alkali metal hydroxide increases in the second electrolyte of the anode part. It is analyzed that since an AOR is a reaction using OH⁻ ions as a reactant, as a concentration of alkali metal hydroxide increases, a rate of an ammonia decomposition reaction is accelerated.

Also, referring to FIG. 10, it can be seen that when a concentration of ammonia in the second electrolyte was 2 M, initial performance was excellent as compared with when the concentration of ammonia was 1 M. However, when the concentration of ammonia in the second electrolyte was 2 M, the performance decreased sharply after 5 cycles. This is analyzed to be due to a phenomenon in which due to excessive concentration of ammonia causing a side reaction that forms metal oxynitrides, as a CV cycle progresses, performance decreases. Accordingly, a concentration of ammonia of about 1 M seems to be most appropriate.

### Example 5—Removal of Chemical Poisoning (Chemisorption) of Electrode Through Reduction Reaction

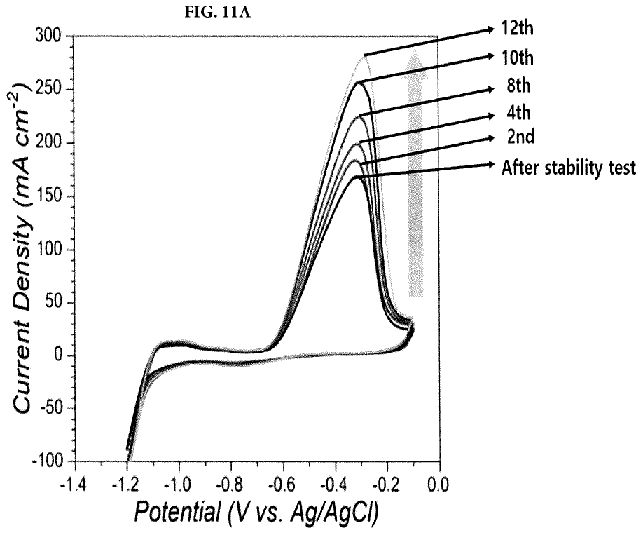

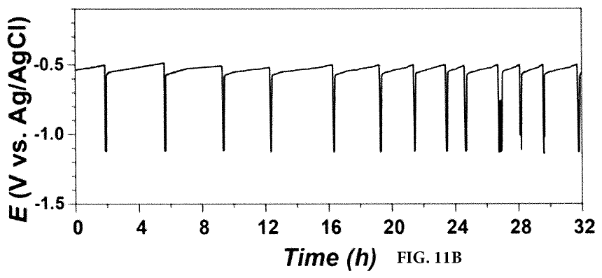

A hydrogen production system as in Example 1 was manufactured. As the hydrogen production system was operated, intermediate products resulting from the decomposition of ammonia were attached to an electrode (anode) to cause chemical poisoning of the electrode. Referring to FIG. 11B, when an AOR is performed, the progress of poisoning can be seen from a change in which a voltage with respect to a reference electrode of Ag/AgCl shifts from about −0.55 to linearly rise. In order to stabilize the electrode from such poisoning to recovery battery performance, after a threshold was set to a voltage of −0.5 V, a cathodic scan was performed at a current density of 50 mA/cm² for 5 minutes. Referring to FIG. 11B, it can be seen that, by performing the above-described cathodic scan, when an AOR is performed after a reduction reaction is performed, a voltage is recovered near −0.55 V. FIG. 11A shows an electrode performance recovery trend according to a cathodic scan during CV measurement.

### Example 6—Manufacturing of Composite Hydrogen Production Stack

A fastening plate (end plate), a current collector plate, a composite electrode separator, a current collector plate, a composite electrode separator, a current collector plate, and a fastening plate (end plate) were sequentially stacked to manufacture a composite hydrogen production stack.

Specifically, the composite electrode separator is manufactured as a separation part using PTFE, EPDM, composite PP, or the like, and a transport part including an input/output hole and a flow path is designed on two surfaces of the separation part through computer numerical control (CNC) processing or etching. An anode, a membrane, and a cathode may be sequentially formed in a reaction part which is an empty space other than the transport part. Specifically, the anode and the cathode may be formed through electrochemical plating, spray coating, PVD, or hydrothermal synthesis. The anode and cathode included at least one metal catalyst selected form platinum (Pt), iridium (Ir), rhodium (Rh), ruthenium (Ru), iron (Fe), cobalt (Co), nickel (Ni), and copper (Cu). Fumasep-fbm-pk which was a bipolar membrane was used as the membrane.

In this case, pH was adjusted to 7 using a 1 M KHCO₃ aqueous solution as an electrolyte included in a reactant flowing in through a cathode input/output hole. pH was adjusted to 15 using a 1 M NH₃ aqueous solution and a 5 M KOH aqueous solution as an electrolyte included in a reactant flowing in through an anode input/output hole.

In addition, a titanium plate was used as the current collector plate.

### Example 7—Analysis of Composite Hydrogen Production Stack Mechanism According to Concentration Range of Input Oxygen

As a method of evaluating an influence of a concentration of oxygen input after the composite hydrogen production stack was manufactured according to Example 6,

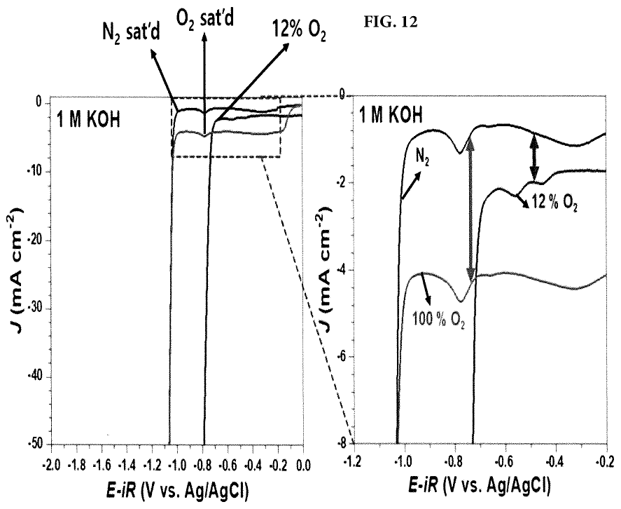

by using open circuit voltage (OCV) and linear sweep voltammetry (LSV), a cell potential was measured. Results of measurement are shown in FIG. 12. Specifically, FIG. 12 is a graph showing the results of measuring the cell potential of the composite hydrogen production stack according to Example 6.

Referring to FIG. 12, when a concentration of oxygen was 12% or less, it could be confirmed that a reaction occurred in which electrons of the cathode reacted with water (H₂O) to generate hydrogen (H₂). When a concentration of oxygen dissolved in a first electrolyte in the cathode part was more than 12%, it could be confirmed that electrons of the cathode reacted with water (H₂O) and oxygen (O₂) to generate hydroxide ions (OH⁻).

Accordingly, an AOR continue spontaneously to efficiently produce power, and also in a case in which the composite hydrogen production stack needs to produce only power, when an amount of input oxygen is increased through an oxygen adjustment part, a cell potential may be maintained in a normal range, and thus a reaction as shown in Reaction Formula 3 may occur in the cathode part, thereby obtaining an advantage in that power is more efficiently produced. In a case in which the composite hydrogen production stack needs to produce power and hydrogen, when an amount of input oxygen is reduced through the oxygen adjustment part, although a cell potential may be reduced to some extent for hydrogen production, there is an advantage in that a reaction as shown in Reaction Formula 2 above may occur at the cathode to produce hydrogen.

### Example 8—Reaction Analysis of Composite Hydrogen Production Stack

After the composite hydrogen production stack was manufactured according to Example 6, a reaction situation according to a cell potential was analyzed.

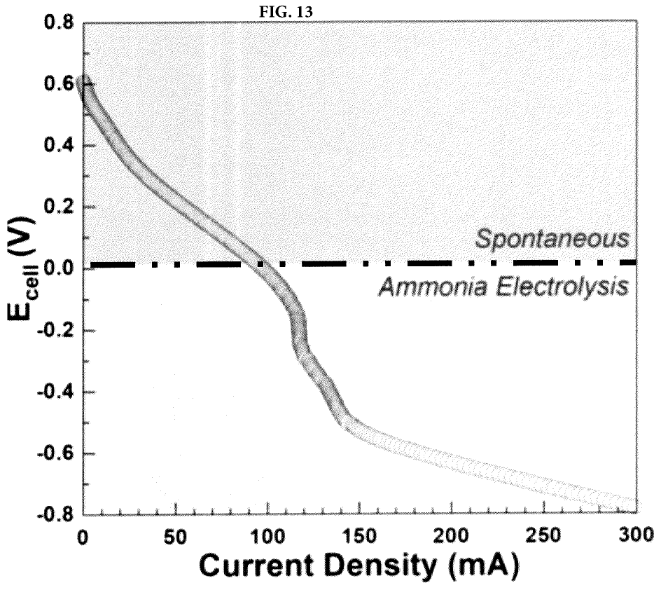

FIG. 13 is a graph of current density according to a cell potential of the composite hydrogen production stack according to Example 6.

Referring to FIG. 13, similar to the hydrogen production system of FIG. 7, a spontaneous reaction occurred in which a current density of more than 0 mA/cm² and less than or equal to 100 mA/cm² was generated at a cell potential ranging from 0 V to 0.6 V. It could be confirmed that an ammonia water electrolysis reaction occurred at a current density exceeding 100 mA/cm².

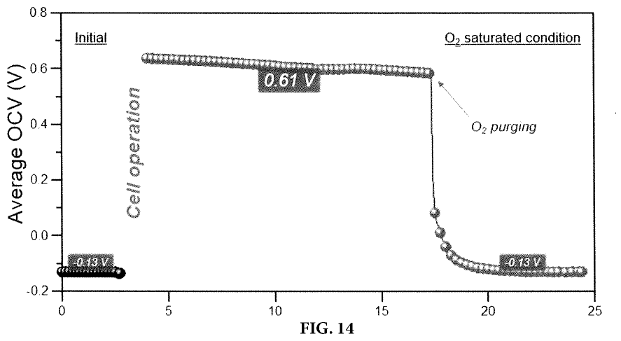

Meanwhile FIG. 14 is a graph of analyzing a reaction according to the addition of oxygen in the composite hydrogen production stack according to Example 6.

Referring to FIG. 14, it can be confirmed that, in an initial stack, a spontaneous reaction occurs due to the presence of oxygen, and a nonspontaneous reaction, which is an ammonia water electrolysis reaction, occurs through stack driving. Next, it can be confirmed that a spontaneous reaction occurs again after oxygen addition (O₂ purging).

That is, in the composite hydrogen production stack according to one embodiment, an amount of oxygen may be adjusted to produce hydrogen gas and power together or produce only power, and also only hydrogen gas may be produced through an ammonia water electrolysis reaction.

### Example 9—Manufacturing of Ammonia Fuel Cell

The pH of a cathode part was adjusted to 7 using 1 M KHCO₃ aqueous solution as a first electrolyte.

A cathode was provided through an electrodeposition method. In this case, the cathode included an electric catalyst synthesized from at least one metal selected from the group consisting of platinum (Pt), iridium (Ir), rhodium (Rh), ruthenium (Ru), iron (Fe), cobalt (Co), nickel (Ni), and copper (Cu). An oxygen adjustment part passage configured to adjust an amount of oxygen input to a first accommodation space and a control part configured to adjust the same were installed.

The pH of an anode part was adjusted to 15 using 1 M NH₃ aqueous solution and a 5 M KOH aqueous solution as a second electrolyte, and an anode was provided through an electrodeposition method. In this case, the anode included an electric catalyst synthesized from at least one metal selected from the group consisting of platinum (Pt), iridium (Ir), rhodium (Rh), ruthenium (Ru), iron (Fe), cobalt (Co), nickel (Ni), and copper (Cu).

As an connection part, a connection passage for connecting the first accommodation space and a second accommodation space was formed using EPDM, PEEK, or the like, and then Fumasep FAS-PET-75 was provided as an anion exchange membrane and provided inside the connection passage, thereby finally manufacturing an ammonia fuel cell.

### Example 10—Manufacturing of Ammonia Fuel Cell with Pretreated Anion Exchange Membrane

An ammonia fuel cell was manufactured in the same manner as in Example 1, except that an anion exchange membrane in a connection part was pretreated through an impregnation process unlike Example 1. In this case, a pretreatment solution for impregnating may be an alkaline solution, for example, NaOH, KOH, or LiOH.

### Example 11—Analysis of Ammonia Fuel Cell Mechanism According to Concentration Range of Input Oxygen

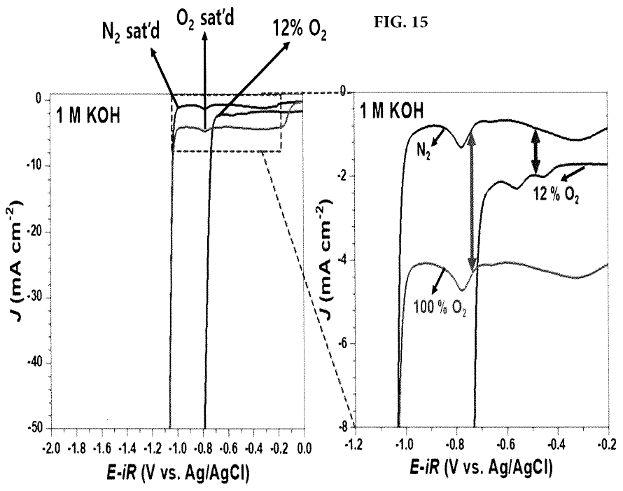

As a method of evaluating an influence of a concentration of oxygen input after the composite hydrogen production stack was manufactured according to Example 9, by using OCV and LSV, a cell potential was measured. Results of measurement are shown in FIG. 15. Specifically, FIG. 15 is a graph showing the results of measuring the cell potential of the ammonia fuel cell according to Example 9.

Referring to FIG. 15, when a concentration of oxygen was 12% or less, it could be confirmed that a reaction occurred in which electrons of a cathode part reacted with water (H₂O) to generate hydrogen (H₂). When a concentration of oxygen dissolved in a first electrolyte of the cathode part was more than 12%, it was could confirmed that electrons of the cathode part reacted with water (H₂O) and oxygen (O₂) to generate hydroxide ions (OH⁻).

Accordingly, an AOR may continue spontaneously to efficiently produce power, and also when an ammonia fuel cell needs to produce only power, when an amount of input oxygen is increased through an oxygen adjustment part, a cell potential may be maintained in a normal range, and thus a reaction as shown in Reaction Formula 6 above may occur in the cathode part, thereby obtaining an advantage in that power is more efficiently produced. When the ammonia fuel cell needs to produce power and hydrogen, when an amount of input is reduced through the oxygen adjustment part, although a cell potential may be decreased to some extent for hydrogen production, there is an advantage in that a reaction as shown in Reaction Formula 5 above may occur in the cathode part to produce hydrogen.

### Example 12—Analysis of Cell Efficiency Through Anion Exchange Membrane Pretreatment Process

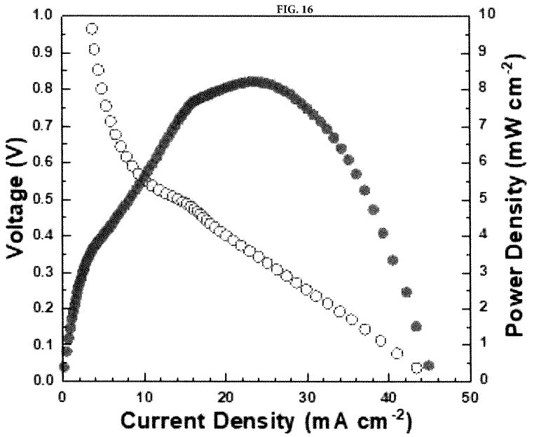

The cell efficiency of the ammonia fuel cell including the pretreated anion exchange membrane according to Example 10 was analyzed using LSV. Results thereof are shown in FIG. 16.

Specifically, FIG. 16 is a graph showing the results of analyzing the ammonia fuel cell including the pretreated anion exchange membrane according to Example 10 using LSV.

As a result, it could be confirmed that when the anion exchange membrane was subjected to a pretreatment process, anions could be selectively transferred through a functional group in the anion exchange membrane.

That is, by using ammonia as a fuel, the ammonia fuel cell according to one embodiment is an eco-friendly energy source, it is relatively easy to supply a fuel, ammonia has a narrower explosion range than hydrogen and is easy to store and transport because it can be liquefied at low pressure. In addition, it is easy to detect leaks due to the unique smell of ammonia, and when ammonia wastewater is used, there is an advantage in that electricity can be produced at the same time when wastewater is treated. The ammonia fuel cell is an electrochemical system in which a spontaneous electrochemical potential is generated, and a concentration of oxygen is adjusted to adjust a cell potential and generate hydrogen (H₂) as needed. Thus, there is an advantage in that the generated hydrogen (H₂) can be used as a fuel for other fuel cells and introduced into a composite fuel cell system.

Although the present invention has been described with reference to exemplary embodiments, it will be understood by those skilled in the art that various modifications and changes can be made in the present invention without departing from the spirit and scope of the present invention as defined in the appended claims.

1. A hydrogen production system comprising:
a cathode part including a cathode and a first electrolyte;
an anode part including an anode and a second electrolyte; and
a bipolar membrane disposed between the cathode part and the anode part,
wherein the first electrolyte is neutral,
the second electrolyte is alkaline and includes ammonia, and
hydrogen is generated in the cathode part.

2. The hydrogen production system of claim 1, wherein the cathode includes a hydrogen evolution reaction catalyst.

3. The hydrogen production system of claim 2, wherein the hydrogen evolution reaction catalyst includes at least one selected from the group consisting of a metal foam, a metal thin film, carbon paper, carbon fiber, carbon felt, carbon cloth, and a platinum catalyst.

4. The hydrogen production system of claim 1, wherein the anode includes at least one metal catalyst selected from platinum (Pt), iridium (Ir), rhodium (Rh), ruthenium (Ru), iron (Fe), cobalt (Co), nickel (Ni), and copper (Cu).

5. The hydrogen production system of claim 1, wherein the first electrolyte has a pH of 6 to 8.

6. The hydrogen production system of claim 1, wherein the second electrolyte has a pH of 12 to 15.

7. The hydrogen production system of claim 1, wherein the first electrolyte is a neutral aqueous electrolyte, and
the second electrolyte is an alkaline aqueous electrolyte including ammonia.

8. The hydrogen production system of claim 7, wherein the alkaline aqueous electrolyte is an alkaline aqueous solution in which at least one selected from alkali metal hydroxides is dissolved.

9. The hydrogen production system of claim 8, wherein the alkali metal hydroxide is at least one selected from the group consisting of KOH, NaOH, and LiOH.

10. The hydrogen production system of claim 1, wherein the bipolar membrane decomposes water into protons (H⁺) and hydroxide ions (OH⁻),
the protons (H⁺) move to the first electrolyte, and
the hydroxide ions (OH⁻) move to the second electrolyte.

11. The hydrogen production system of claim 1, wherein an ammonia oxidation reaction, in which ammonia reacts with hydroxide ions (OH⁻) and is oxidized to produce nitrogen (N₂), occurs in the anode part.

12. The hydrogen production system of claim 1, wherein a temperature of the anode part is 30° C. or more.

13. The hydrogen production system of claim 8, wherein a concentration of the alkaline aqueous solution is 1 M or more.

14. The hydrogen production system of claim 1, wherein a concentration of the ammonia is in a range of 0.7 M or more and 1.3 M or less.

15. The hydrogen production system of claim 1, wherein the hydrogen in the cathode part is generated through a hydrogen evolution reaction in which protons (H⁺) combine with electrons of the cathode to generate hydrogen (H₂).

16. The hydrogen production system of claim 1, further comprising an oxygen adjustment part connected to the cathode part to adjust an amount of oxygen input to the cathode part.

17. The hydrogen production system of claim 1, wherein, when a concentration of oxygen dissolved in the first electrolyte in the cathode part is 12% or less, electrons in the cathode part react with water (H₂O) to generate hydrogen (H₂).

18. The hydrogen production system of claim 1, wherein, when a concentration of oxygen dissolved in the first electrolyte in the cathode part is greater than 12%, electrons in the cathode part react with water (H₂O) and oxygen (O₂) to generate hydroxide ions (OH⁻).

19. A method of stabilizing an electrode by removing poisoning from a poisoned electrode in a hydrogen production system, the method comprising performing a cathodic scan on the hydrogen production system,
wherein the hydrogen production system includes a cathode part including a cathode and a first aqueous electrolyte, an anode part including an anode and a second aqueous electrolyte, and a bipolar membrane disposed between the cathode part and the anode part, wherein a hydrogen evolution reaction occurs in the cathode part, and an ammonia oxidation reaction occurs in the anode part.

20. A combined power generation system comprising:
a renewable energy generation unit configured to produce power from renewable energy;
a hydrogen production unit configured to receive the power produced from the renewable energy generation unit; and
a fuel cell configured to receive hydrogen from the hydrogen production unit,
wherein the hydrogen production unit is the hydrogen production system of claim 1.

21. The combined power generation system of claim 20, further comprising a hydrogen storage unit configured to store the hydrogen produced in the hydrogen production unit.

22. The combined power generation system of claim 20, further comprising an electric energy storage unit configured to store the power produced from the renewable energy generation unit.

23. A composite electrode separator comprising:
a separation part having a plate shape;
a transport part formed on each of two surfaces of the separation part and having a flow path through which a reactant and a product flow and an input/output hole through which the reactant flows in and the product flows out;
a reaction part having an area other than the transport part formed on each of the two surfaces; and
an electrode part positioned in the reaction part and including a cathode, an anode, and a bipolar membrane disposed between the cathode and the anode.

24. The composite electrode separator of claim 23, wherein the input/output hole includes a cathode input/output hole and an anode input/output hole.

25. The composite electrode separator of claim 23, wherein a cathode input/output hole further includes an oxygen adjustment part configured to adjust an amount of oxygen of the reactant flowing into the transport part.

26. The composite electrode separator of claim 23, wherein a hydrogen ion concentration of the reactant flowing in through a cathode input/output hole is in a range of pH 6 to pH 8.

27. The composite electrode separator of claim 23, wherein a hydrogen ion concentration of the reactant flowing in through the input/output hole is in a range of pH 12 to pH 15.

28. The composite electrode separator of claim 23, wherein the electrode part has a specific surface area of 5 m²/g to 100 m²/g and a pore size of 0.02 μm to 12 μm.

29. A composite hydrogen production stack comprising one or more unit cells each including the composite electrode separator of claim 23 and current collector plates positioned on two surfaces of the electrode separator.

30. The composite hydrogen production stack of claim 29, wherein, when a concentration of oxygen in the reactant flowing in through a cathode input/output hole is 12% or less, electrons of the cathode react with water (H₂O) to discharge hydrogen (H₂) as a product.

31. The composite hydrogen production stack of claim 29, wherein, when a concentration of oxygen in the reactant flowing in through a cathode input/output hole is more than 12%, electrons of the cathode react with water (H₂O) and oxygen (O₂) to generate hydroxide ions (OH⁻).

32. The composite hydrogen production stack of claim 29, wherein ammonia (NH₃) and hydroxide ions (OH⁻) are oxidized at the anode to discharge nitrogen (N₂) as a product through an anode input/output hole.

33. The composite hydrogen production stack of claim 29, wherein a spontaneous reaction, in which a current density of more than 0 mA/cm² and less than or equal to 100 mA/cm² is generated at a cell potential ranging from 0 V to 0.6 V, occurs.

34. The composite hydrogen production stack of claim 29, wherein a current density exceeding 100 mA/cm² is generated through an ammonia water electrolysis reaction.

35. An ammonia fuel cell comprising:
a cathode part including a first electrolyte accommodated in a first accommodation space and a cathode of which at least a portion is submerged in the first electrolyte;
an anode part including a second electrolyte accommodated in a second accommodation space and a metal anode of which at least a portion is submerged in the second electrolyte; and
a connection part including a connection passage configured to communicate the first accommodation space with the second accommodation space, and an anion exchange membrane provided in the connection passage to allow anions to move,
wherein the first electrolyte is neutral,
the second electrolyte includes ammonia (NH₃) and is alkaline, and
nitrogen (N₂) is generated in the anode part.

36. The ammonia fuel cell of claim 35, further comprising an oxygen adjustment part connected to the first accommodation space of the cathode part to adjust an amount of oxygen input to the first accommodation space.

37. The ammonia fuel cell of claim 35, wherein, when a concentration of oxygen dissolved in the first electrolyte in the cathode part is 12% or less, electrons in the cathode part react with water (H₂O) to generate hydrogen (H₂).

38. The ammonia fuel cell of claim 35, wherein, when a concentration of oxygen dissolved in the first electrolyte in the cathode part is more than 12%, electrons in the cathode part react with water (H₂O) and oxygen (O₂) to generate hydroxide ions (OH⁻).

39. The ammonia fuel cell of claim 35, wherein the anion exchange membrane is pretreated in an alkaline environment.

40. The ammonia fuel cell of claim 35, wherein the pretreatment is performed using an alkaline solution at 0.1 M to 1 M.

41. The ammonia fuel cell of claim 35, wherein, in the anode part, ammonia (NH₃) and hydroxide ions (OH⁻) are oxidized to generate nitrogen (N₂).

42. The ammonia fuel cell of claim 35, wherein a hydrogen ion concentration of the first electrolyte is in a range of pH 6 to pH 8.

43. The ammonia fuel cell of claim 35, wherein a hydrogen ion concentration of the second electrolyte is in a range of pH 12 to pH 15.

44. The ammonia fuel cell of claim 35, wherein the second electrolyte includes an alkaline aqueous solution in which an alkali metal oxide is dissolved.

45. The ammonia fuel cell of claim 35, wherein a current density of more than 0 mA/cm² and less than or equal to 50 mA/cm² is generated at a cell potential ranging from 0 V to 1.0 V.
